(19) United States
(12) Patent Application Publication
(10) Pub. No.: US 2011/0107241 A1
(43) Pub. Date: May 5, 2011

(54) SYSTEM AND METHOD FOR TRACKING USAGE

(75) Inventor: Cameron Stewart Moore, Victoria (AU)

(73) Assignees: Cameron Stewart Moore, Richmond, Victoria (AU); Movideo Ply Ltd., Richmond, Victoria (AU)

(21) Appl. No.: 12/989,296

(22) PCT Filed: Apr. 24, 2009
(86) PCT No.: PCT/AU2009/000519

§ 371 Date: Dec. 9, 2010

Related U.S. Application Data
(60) Provisional application No. 61/047,506, filed on Apr. 24, 2008.
(60) Provisional application No. 61/157,606, filed on Mar. 5, 2009.

(51) Int. Cl. G06F 3/048; G06F 15/173

(52) U.S. Cl. 715/760; 715/783; 715/769; 709/224

(57) ABSTRACT

A usage data analysis system, including an application server for accessing and processing usage data representing use of items, and serving an interface, including: selectable identifiers, associated with the items to select items for display as filtered items according to the selected identifier; and selectable views for presenting data associated with the filtered items, including at least one of: (i) demographic data associated with users of the items, (ii) numbers of users of the items, (iii) comparison data between the filtered items, (iv) geographic data associated with the location of the users, and (v) tag map data based on the filtered items having tags associated with the items, and presenting the relationship between the tagged items.

### FIELD

The present invention relates to a system and method for tracking usage or activity, and in particular for presenting or visualising media usage, resource usage or measurement data.

### BACKGROUND

In an environment with many media sources, it is often difficult to determine media usage, e.g. relating to relative popularity of the sources among media users, or viewers. In the case of websites, a ranking website may rank other websites by their popularity. The popularity of the websites may be estimated by the number of votes that users select, i.e. a rating for each website selected by previous viewers; however, these ranking systems may be quickly obsolete or dated or may be skewed by certain viewers who submit ratings more frequently. The popularity of the websites may also be estimated based on the number of users that view respective websites (e.g. calculated by page loads); however, this data may be obsolete or dated before it is compiled and presented to the media user.

In addition, a user playing a media resource may wish to communicate with other users associated with that media source, but may have difficulty locating such other users, and/or initiating communication with them.

Furthermore, data relating to media usage is often voluminous, and detailed, and is difficult to present in a way that makes it easy, or even possible, to identify important features or properties in the usage data. Media usage data, such as audience measurement data for television, radio and Internet traffic, is collected using a variety of techniques, but the volume of data collected and the extent of the parameters that can be accessed make it technically difficult for the data to be analysed and presented in a manner that can be effectively utilised. Similar considerations apply to other forms of activity data that is collected, such as retail sales data, stock or inventory data, and logistics or transport data. It is desired to address or ameliorate the above, or to at least provide a useful alternative.

### SUMMARY

The present invention provides a method of generating a user interface on a client computer device for displaying resource item usage, including:
generating a display, in a first part of the interface, of available resource items associated with usage data, said items being selectable using the interface;
receiving a selection of the resource items from the available resource items in said first part;
generating a display of filtered resource items in a second part of said interface based on the selection;
receiving a selection of a view associated with at least one property of the filtered items; and
generating a display, in a third part of said interface, of said view using the filtered resource items' usage data associated with said at least one property.

The system also provides a usage data analysis system, including an application server for accessing and processing usage data representing use of items, and serving an interface, including:
selectable identifiers, associated with said items to select items for display as filtered items according to the selected identifier; and
selectable views for presenting data associated with the filtered items, including at least one of:
   (i) demographic data associated with users of the items,
   (ii) numbers of users of said items,
   (iii) comparison data between said filtered items,
   (iv) geographic data associated with the location of said users, and
   (v) tag map data based on said filtered items having tags associated with the items, and presenting the relationship between the tagged items.

The present invention also provides a system for tracking usage, including:
a capture server for receiving usage data, indicating that a resource is being used by a visitor using a visitor client, from a tracking module having been served to the visitor client, and a report server for serving report data in real-time, based on usage data, on the visitor client devices using a plurality of resources.

The present invention also provides a usage data analysis system, including an application server for serving code for generating a comparison view in real-time presenting a comparison between historical usage data and real-time usage data, said usage data representing use of a resource by a user.

### BRIEF DESCRIPTION OF THE DRAWINGS

Preferred embodiments are hereinafter described, by way of example only, with reference to the accompanying drawings, which are not to scale, wherein:

FIG. 1 is a schematic diagram of a tracking system for tracking usage;

FIG. 2 is a schematic diagram of hardware elements of the tracking system of FIG. 1;

FIG. 3 is a diagram showing a geographical distribution of data centres of the tracking system;

FIG. 4 is a schematic diagram showing the geographical distribution of the tracking system, having been reconfigured to allow for a non-functional data centre;

FIG. 5 is a schematic diagram of software modules of the tracking system;

FIG. 6 is a schematic diagram of the tracking system including a tracking module, a capture server, an Application Program Interface (API) server, an API client, and a data store;

FIG. 7 is a block diagram with details of the capture server;

FIG. 8 is a block diagram with details of the API server;

FIG. 9 is a block diagram of data entity relationships in the tracking system;

FIG. 10 is a block diagram with details of the data store;

FIG. 11 is a block diagram showing data relationships within the data store.

FIG. 12 is a class diagram detailing data storage classes in the data store;

FIG. 13 is a flowchart of a tracking process performed by the tracking system;

FIG. 14 is a flowchart of a tracking data validation process of a data ingestion process performed by at least one node in the store;

FIG. 15 is a flowchart of a reporting process performed by the API server;

FIG. 16 is a flowchart of a cluster selection process performed by the capture server and the API server;

FIG. 17 is a flowchart-of an aggregation process performed by the API server;

FIG. 18 is a flowchart of an input-output (IO) request process performed by an IO invocation handler of the store;

FIG. 19 is a flowchart of a store receive process performed by the store;

FIG. 20 is a flowchart of the data ingestion process;

FIG. 21 is an expiration process performed by the store;

FIGS. 22 to 41 are screenshots of a user interface of the API client;

FIG. 42 is a block diagram of a display of the tracking system;

FIG. 43 is a block diagram of a display process of the tracking system;

FIGS. 44 and 45 are screen shots of a user interface of the display;

FIG. 46 is a screen shot of a media wall user interface;

FIG. 47 is a schematic diagram of an alternative hardware configuration of the tracking system; and

FIG. 48 is a block diagram of a services architecture of the tracking system.

### DETAILED DESCRIPTION

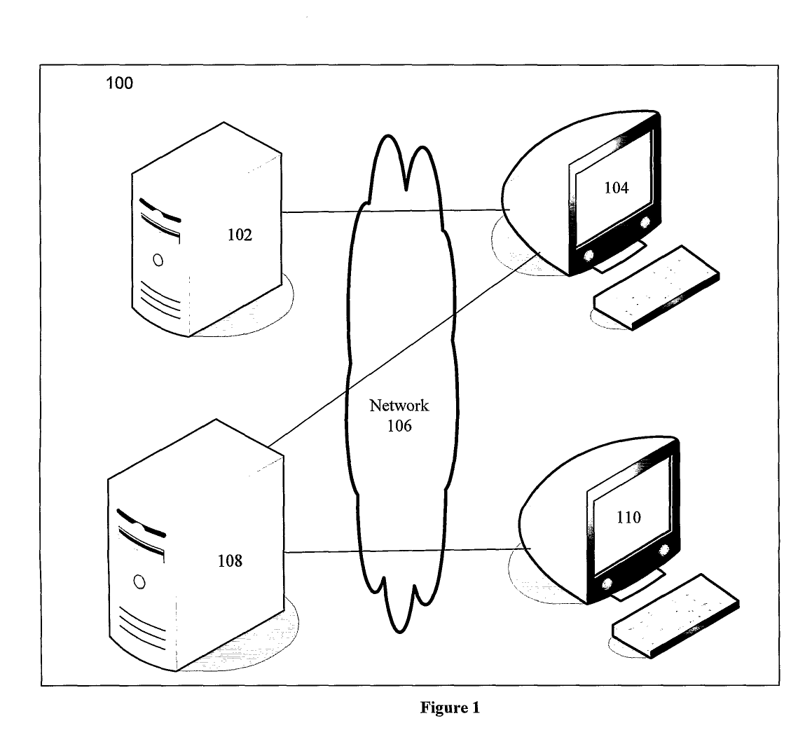

A tracking system 100, shown in FIG. 1, includes a content server system 102 for serving media and/or content to a visitor client device 104 over a network 106, a tracking server system 108 for monitoring usage by the visitor client device 104, and an observer client device 110 for receiving reports from the tracking server system 108 of the usage by the visitor client device 104. The visitor client device 104 is, for example, a computing device being used by a visitor using a website provided by the server system 102. The server system 102 could be any system capable of delivering content, such as a set top box, broadcast system or on demand system, to client device 104, such as a computer, phone, audio player, which is able to use, play, render or present the content data. The observer client device 110 is a computing device used by an observer to track or monitor usage by the visitor. The observer client device 110 is any device which is able to process and present the user interface components served by the tracking server system 108. The tracking server system is able to access usage and activity data, analyse the data and provide unique user interface components for selectively presenting and visualising the data. The usage or activity data includes real-time or stored audience measurement data. The data may also be real-time or stored sales data, stock data, logistics or transport data.

The tracking system 100 allows developers, site owners and other observers to use real-time metrics based on media content and visitor viewing pattern information. The tracking system 100 also allows visitors and observers to be provided with real-time data concerning usage of available media content by other visitors.

Hardware Configuration 200

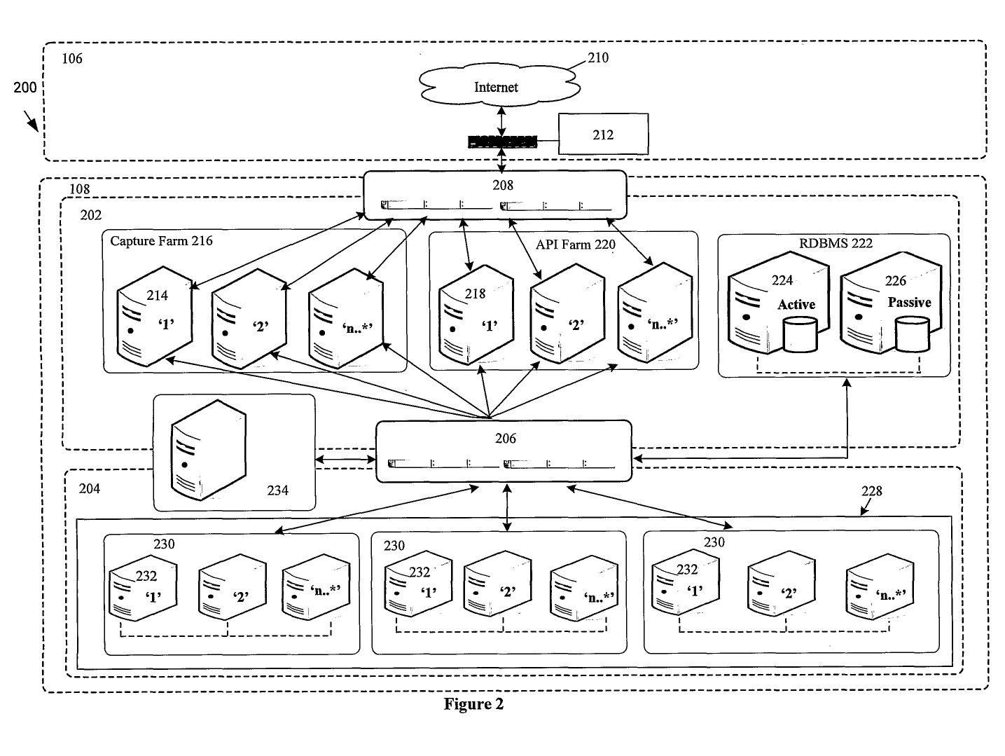

The hardware configuration 200 of the tracking system 100, shown in FIG. 2, includes a plurality of networks, connected by load balancers, and a plurality of data servers connected to each other by the networks. The tracking server system 108 includes a demilitarised zone (DMZ) network 202 and a private network 204 connected by an internal load balancer 206, which is clustered to be able to failover to a backup load balancing device. The tracking server system 108 is in communication with the network 106, which includes a public data network in the form of the Internet 210, via an external load balancer 208, which is configured as a firewall and for clustered failover, and a router/switch 212, such as Cisco 65xx series switch. The external load balancer 208 connects at least one capture server 214, in a capture server machine, in a capture server farm 216 to the Internet 210. A capture server 214 is able to communicate with the Internet 210 and the visitor client device 104. Also connected to the Internet 210 via the external load balancer 208 is at least one API server 218, in an API server machine, as part of an API server farm 220, which is able to communicate with the observer client device 110 via the Internet 210. The capture server 214 and the API server 218 are both connected to a Relational Database Management System (RDBMS) 222 in the form of database servers configured for clustered failover. The RDBMS 222 includes an active database 224 for communicating with other components of the tracking server system 108, and a passive database 226 for redundantly providing a back-up copy of the data in the active database 224. The capture server 214 and the API server 218 communicate with a data store 228 on the private network 204 via the internal load balancer 206. The data store 228 provides rapid storage and retrieval of usage, or tracking data generated by the tracking server system 108. The store 228 includes at least one store cluster 230, and each store cluster 230 includes at least one storage node 232 in a node machine. Each storage node 232 communicates with all other storage nodes 232 in each store cluster 230 using a Universal Data Protocol (UDP) broadcast (multicast) protocol that provides sharing of data between the nodes 232 of each store cluster 230. Having a plurality of nodes 232 in each cluster 230 allows for redundant data storage and back-up. Having a plurality of clusters 230 in the store 228 allows for a large volume of data to be stored and retrieved quickly by the capture servers 214 and the API servers 218.

The tracking server system 108 includes a management server 234 in communication with other elements of the tracking server system 108 via the internal load balancer 206. The management server 234 allows for configuration and management of the tracking server system 108, and monitors and manages the other servers, e.g. in relation to new software, or software updates.

The RDBMS 222 and the store 228 are accessible to the at least one capture server 214 and the at least one API server 218, but are not accessible, or “open”, to the Internet 210. The capture server 214 and the API server 218 are accessible from the Internet 210, albeit via the external load balancer, and therefore have different Internet Protocol (IP) addresses, e.g. “192.168.1.0” and “192.168.2.0” respectively. The RDBMS 222 is only accessible to the DMZ Network 202 and Private Network 204. Each store cluster 230 is accessible only internally in the private network 204, and does not have an externally available IP address.

The computing machines associated with (i.e. running, or hosting) the capture servers 214, the API servers 218, the database servers of the RDBMS 222, the management server 234 and the storage nodes use standard server hardware, e.g. Intel-based personal computers, using Linux based operating systems, e.g. ‘Ubuntu’, which includes drivers and Java with a Debian GNU core. Each server is configured to have a large number of connections by reducing the Transfer Control Protocol (TCP) timeout from 120 seconds to 15 seconds. The servers in each group of servers, i.e. the capture servers 214 in the capture farm 214, the API servers 218 in the API farm 220, and the nodes 232 in each cluster 230, are load balanced to allow high data traffic, e.g. using a load balancer such as a ‘HAProxy’ proxy.

Each node 232 in each cluster 230 has a copy of the same data through use of clustering based on a “JGroups” API. The JGroups API allows data distribution amongst nodes 232 in each cluster 230 and provides data redundancy in case of a server failure in the cluster 230.

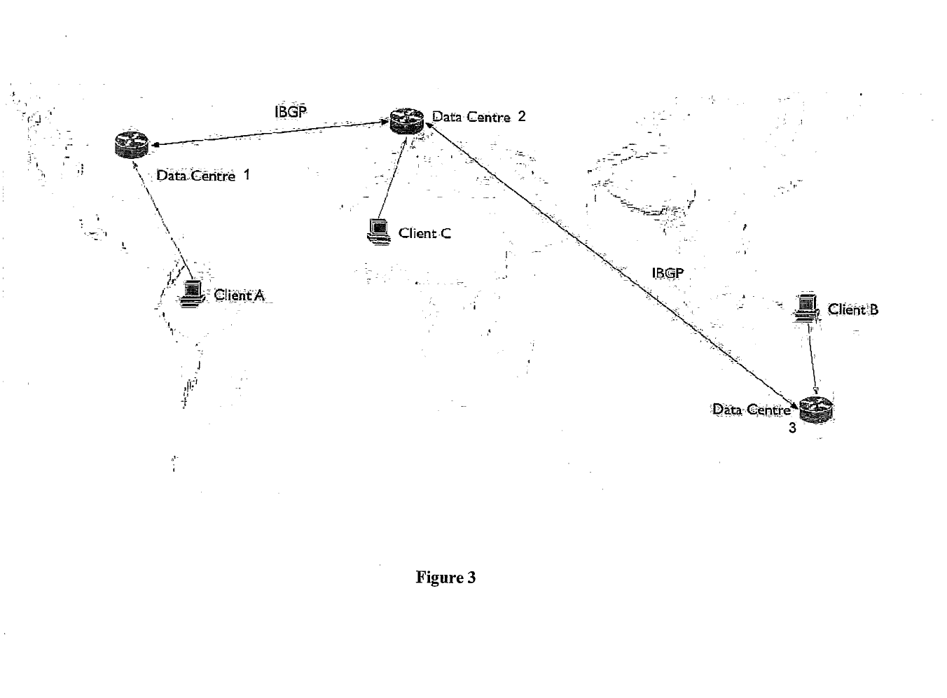

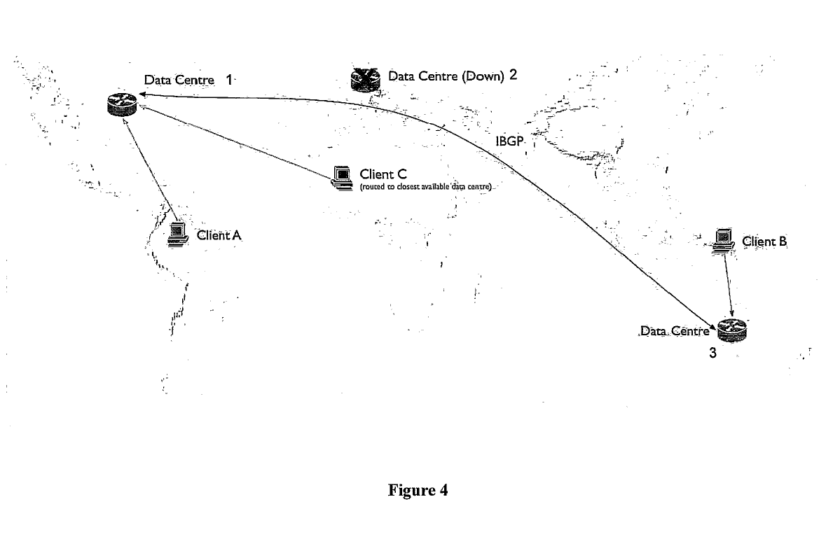

The tracking server system 108 is in communication with the Internet via the router/switcher 212, which allows use of a Border Gateway Protocol (BGP) to run multiple copies of the tracking server system 108 in geographically diverse locations, as shown in FIGS. 3 and 4. The use of the BGP allows for a better user experience for the observer client device 110 as data centres can be located in the proximity of corresponding observers: e.g. an observer client site “Client A” in FIG. 3 has a better bandwidth connection to a “data centre 1” than to “data centre 3”. The use of multiple data centres also provides a globally redundant system for the tracking system 100, which also provides for automatic traffic redirection in the case of the failure of one of the data centres, e.g. if “data centre 2” fails, as shown in FIG. 4 (i.e. “goes down”), “Client C” is routed to the closest available data centre, in this case “data centre 1”. The globally distributed data centres are connected and communicate via an Internal Border Gateway Protocol (IBGP), which allows for the plurality of data centres to remain synchronised while based in geographically diverse locations, e.g. on different continents, or at least in locations which are only distantly connected by the Internet 210.

The hardware configuration of the tracking system 100 provides: scalability in terms of load (e.g. further computing machines and further servers can be added to the capture farm 216, and the API farm 220, and the store 228 to provide the scalability for larger volumes of data and volumes of traffic); redundancy against multiple failure of servers in the tracking server system 108; load balancing between data centres based on location; continuing availability of service while individual servers in the tracking server system 108 are added, removed or reconfigured; and a simple configuration for management by the management server 234.

Software Architecture

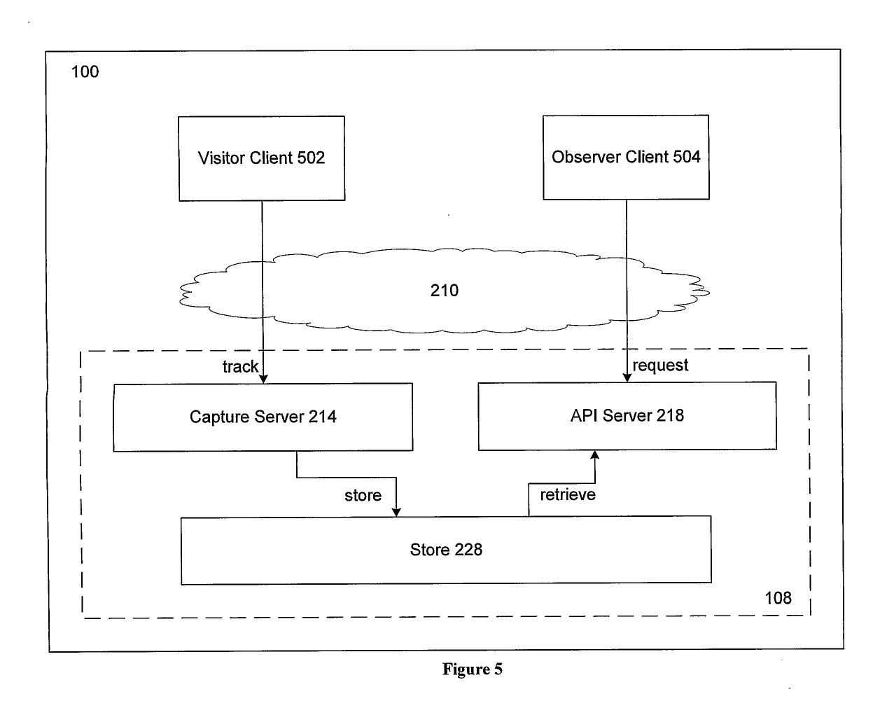

The tracking system 100, in FIG. 5, includes a visitor client 502, in the form of a software module operating on the visitor client device 104, and an observer client 504, being a software module operating on the observer client device 110, in communication with the tracking server system 108 via the Internet 210. The visitor client 502 generates data indicative of media usage by the visitor in the form of tracking data (i.e. capture data, usage data, monitoring data or activity data), which is sent to the capture server 214 and stored in the data store 228. The API server 218 retrieves relevant usage data from the store 228 for generating report data, reporting on the one or many visitors' media usage, then sends the report data to the observer client 504 which provides reports of media usage to an observer.

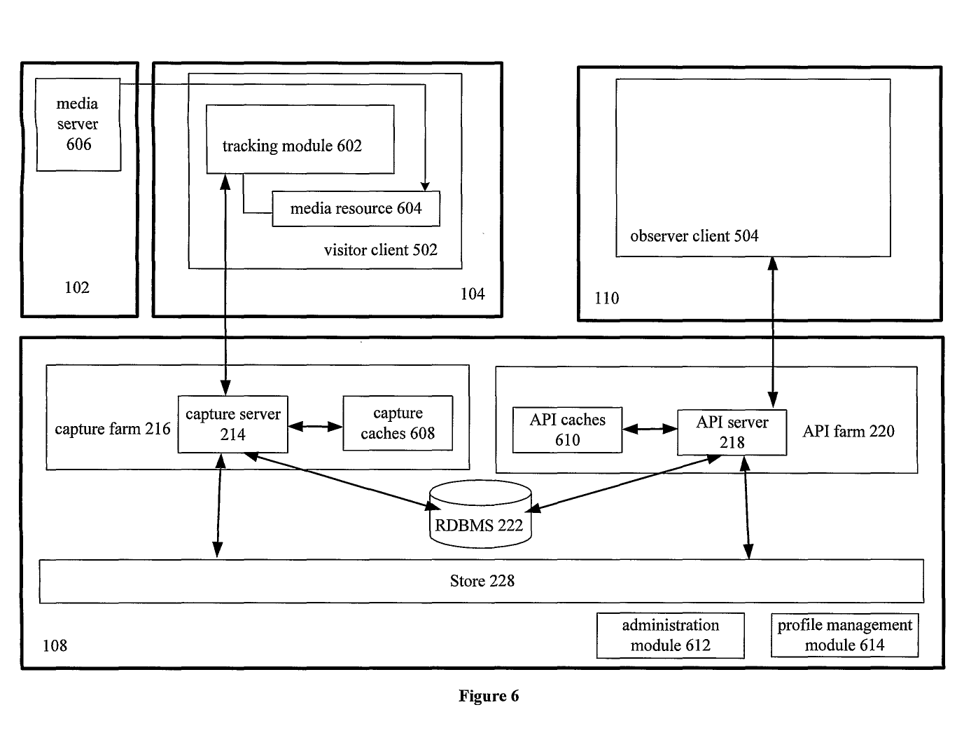

The capture server 214 is in communication with a tracking module 602 associated with the visitor client 502 and a media resource 604, in FIG. 6. The tracking module 602 is in the form of a tracking script, which is a compressed and obfuscated (e.g. encrypted) JavaScript file associated with content viewed by the visitor and associated with the media resource 604. The media resource 604 includes a tag, or reference, (e.g. an HTML tag) that references a location of the tracking module 602 on the capture server 214. The visitor client 502 uses the tag, or references, to request and include (e.g. embed) the tracking module 602 into the media resource 604 while it is being used. The visitor client 502 is a Web browser and the media resource 604 is Web content provided by a media server 606 of the media server system 102, such as streamed video content. The tracking script sends data about media usage to the capture server 214, as described further below. The capture server 214 is in communication with a tracking module 602, the store 228 and the RDBMS 222.

The form and content of the reports is selected by the observer client 504 through observer profile data (e.g. based on observer selections, and selected visitors and media resources 604 associated with the observer) and/or selections made on user interface components processed by the client 504. The observer profile data is also associated with the observer's authentication data.

Tracking Module

The function of the tracking module 602 is to send data regarding the visitor client 502 (e.g. the Web browser type, the Internet Protocol (IP) address, etc.), information about the visitor (e.g. visitor age, username, avatar, etc) pre-selected by a controller of the media resource 604 (e.g. a site owner of a Website), and media resource information (e.g. a title and a description of the media resource 604 in website tags) about media resource 604 being used. The tracking module 602 does this by periodically, or regularly, or continuously sending usage data (e.g. sending tracking requests every X seconds) to the capture server 214. Using the usage data, the tracking server system 108 generates the report data representing: (i) the at least one media content or resource 604 being used by the visitor (e.g. playing a video stream or music file, or viewing a website); (ii) whether the visitor is still using the resource 604 (in real-time updates); and (ii) whether the viewer has started using a different media resource 604, and what that new media resource 604 is (e.g. that the visitor has surfed to a new webpage).

A media supplier (e.g. a site owner or content broadcaster) is able to set custom data for much of the information that gets tracked by the capture server 214. The data sent by the tracking module 602 is selected (e.g. data fields are populated) using meta data tags in the media resource 604 and variables set by the media supplier. For example, Table 1 lists data fields populated by the tracking module 602 and thus the usage data sent to the at least one capture server 214, in an example tracking system 100 being used for tracking use of a website.

TABLE 1

| Name | Post Parameter | Default | Description |
|---|---|---|---|
| Audio | Ma | | URL of an audio file to be associated with the |
| | | | content. |
| Content | Dd | HTML Meta | Description of what the content is or |
| Description | | Description | contains. |
| Content Labels | Dk | HTML Meta | Comma separated list of words that describe |
| | | Keywords | the content. |
| Content Status | S | | Status or error code to be associated with the |
| | | | content. |
| Content | Th | Page Screen Shot | URL of a thumbnail image of the content. |
| Thumbnail | | | |
| Content Title | Dt | HTML Document | Title/Name of the content. |
| | | Title | |
| Content URL | U | Document Location | The URL of the content. |
| Custom | D | | Custom description of what the content is or |
| Content | | | contains. (Over writes the “Content |
| Description | | | Description”) |
| Custom | L | | Comma separated list of words that describe |
| Content Labels | | | the content. (Over writes the “Content |
| | | | Labels”) |
| Custom | T | | Title/Name of the content. (Over writes the |
| Content Title | | | “Content Title”) |
| Image | Mi | | URL of an image to be associated with the |
| | | | content. |
| Last Modified | Ts | Document Last | Time stamp of the last time that the content |
| | | Modified | was modified. |
| Video | Mv | | URL of a video file to be associated with the |
| | | | content. |
| Visitor Age | Ag | | Age of the visitor currently viewing the |
| | | | content. |
| Visitor Alias | A | | Alias or profile name of the visitor currently |
| | | | viewing the content. |
| Visitor Avatar | Av | | URL of an image to be associated with the |
| | | | visitor currently viewing the content. |
| Visitor Date of | Dob | | Visitor currently viewing the contents date of |
| Birth | | | birth. This gets overridden by the |
| | | | myco_visitor_age parameter. |
| Visitor Gender | G | | Gender of the visitor currently viewing the |
| | | | content. The options are: Male, Female or |
| | | | unknown. |
| Visitor Key | K | Generated String | Unique identifier for the visitor. |
| Visitor Label | Vl | | A comma separated list of words to be |
| | | | associated with the visitor currently viewing |
| | | | the content. |
| Visitor Profile | P | | URL to the current visitors profile or |
| URL | | | homepage. |

Caches

The capture server 214 communicates with distributed capture caches 608, which provide for high availability under heavy Web traffic. The distributed capture caches 608 are provided by “Memcached” software provided by Danga Interactive. The API farm 220 also includes distributed caches in the form of distributed API caches 610, which reduce required accessing (i.e. transfer of data) between the API server 218 and the store 228 by retaining cached copies of data received from the store 228 by the API server 218. The distributed API caches 610 are also in the form of “Memcached” software.

Administration and Management

The tracking server system 108 also includes an administration module 612 and a profile management module 614, running on the management server 234, for administration and management of the tracking server system 108. The administration module 612 and the profile management module 614 are used to log, or record, and update other modules and components in the tracking system 100.

Capture Server 214

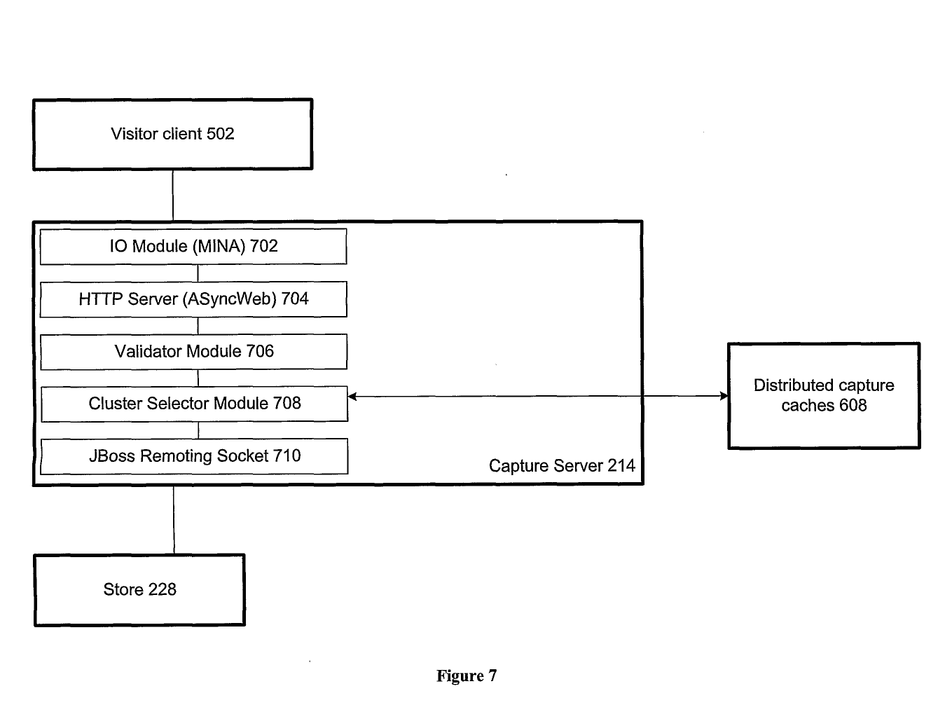

A capture server 214, as shown in FIG. 7, handles basic input and output using an input-output (IO) module 702, in the form of an Apache MINA API as the underlying communications system 702, for a HTTP server in the form of an AsyncWeb protocol handler 704. Both systems 702 and 704 are tuned to meet heavy input-output demands of data capture. The capture server 214 serves the tracking module 602 to the visitor client, and subsequently receives tracking data, in the form of requests, sent by the tracking module 602.

The visitor client 502 transmits tracking data (i.e. data tracking the visitor's usage of media) from the tracking module 602 to the capture server 214 which is received by the IO module 702 and the protocol hander 704 and then sent to a validator module 706 in the capture server 214 to validate incoming tracking data. The capture server 214 includes a cluster selector module 708 for selecting which cluster to send each data message of usage data, in communication with the distributed capture caches 608, and a network connection (e.g. JBoss remoting socket) 710 for transmitting data to the store 228. The cluster selector module 708 selects a cluster based on the network domain from which the usage data is being sent, such as the Internet domain of the media resource 704 being used by the visitor. The network connection 710 uses a JBoss Remoting application program interface (API), which is built using the JGroups project and supported through the JBoss community, and is quicker than default remoting frameworks. Usage data is serialised by the capture server 214 and sent using a one-way request to the selected cluster (of the clusters 230) in the store 228.

The protocol hander 704 handles requests for the tracking script from the visitor client 502, and receives subsequent tracking “requests” sent by the tracking script. These requests contain the usage data from the visitor client 502. The capture server 214 responds to these requests with an empty response.

The capture server 214 is stateless and does not require support for a session, which makes horizontal scalability efficient. The capture servers 214 in the server farm 216 do not need to share any session data, which allows new servers 214 to be added to each server farm 216 when more capacity is required.

API Server 218

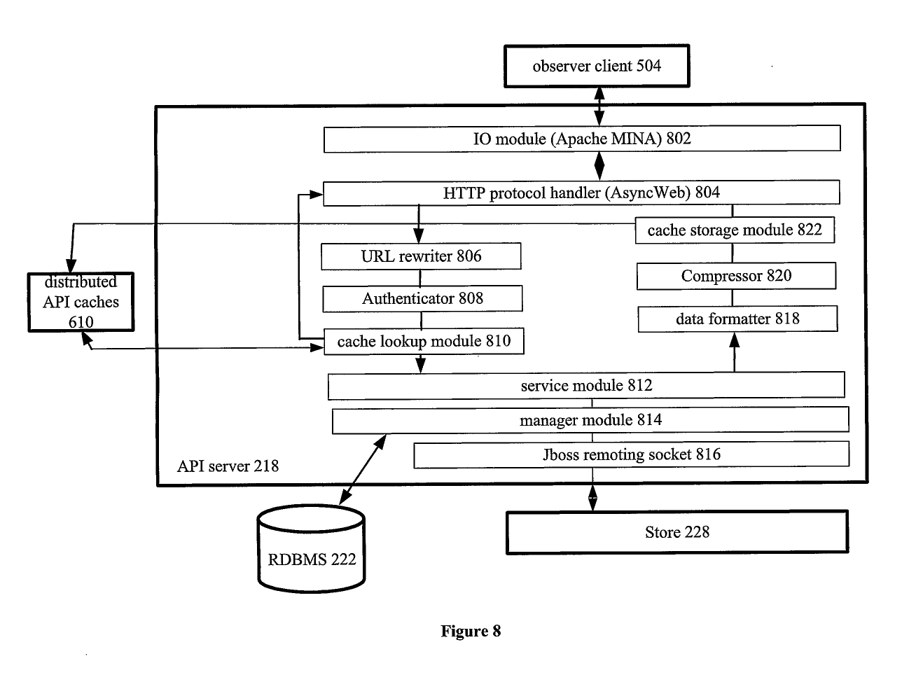

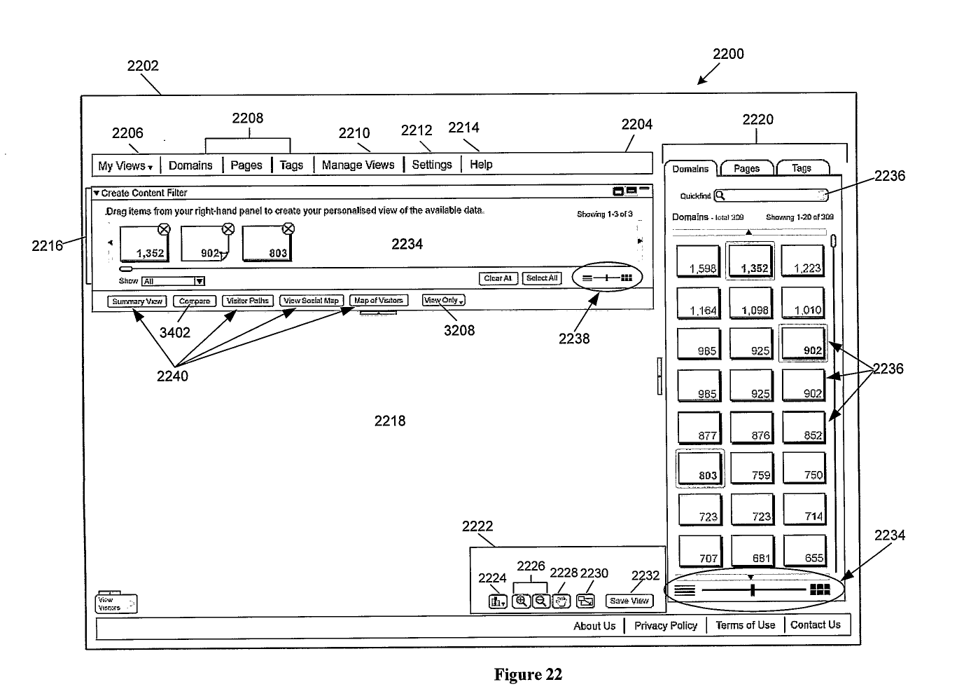

The API server 218, as shown in FIG. 8, includes an input-output (IO) module 802 (based on Apache MINA) and a protocol handler 804 (based on AsyncWeb) equivalent to those of the capture server 214. A framework built on top of the protocol hander 804 provides authentication, data formatting, compression and caching services for requests made by the observer client 504. Any incoming observer request from the observer client 504, e.g. for a particular report, is transmitted to the IO module 802 and the protocol handler 804. The incoming request is sent to a universal resource location (URL) re-writer 806, which matches up a URL with a service module that knows how to handle the specific request (e.g. the URL http://api.myco.com/l/view would get matched up with the “ViewService.class”) and then to an authenticator 808 which authenticates the observer client 504 (based on the observer authentication data) and establishes an authenticated transfer session with the observer client 504. To establish the authenticated session, the server system 108 sends data representing a valid session token to the observer client 504, e.g. using XML “<session-token>” data shown in the Appendix. The authenticator 808 is in communication with a cache look-up module 810 which is in communication with the distributed API caches 610 for searching for and receiving any data being requested by the observer client 504 that is in the distributed API caches 610, and then delivering this data to the protocol handler 804 for transmission back to the observer client 504. The cache look-up module 810 is in communication with a service module 812 and a manager module 814 which transmit report requests to the store 228 via a network connection 816 (using a JBoss remoting socket) of the API server 218. For usage or activity data extracted from the store 228 via the network connection 816, the API server 218 includes a data formatter 818 and a data compressor 820 for formatting and compressing the report data into a form of report as requested by the observer client 504 and presented by the user interface rendered by the client 504 (e.g. as shown in FIGS. 22 to 41). The API server 218 includes a cache storage module 822 for storing any report data, including the compressed and formatted report data, in the distributed API caches 610, e.g. for storing a copy of any report data transmitted to the observer client 504 as the report data may be recycled for a following report by the cache look-up module 810.

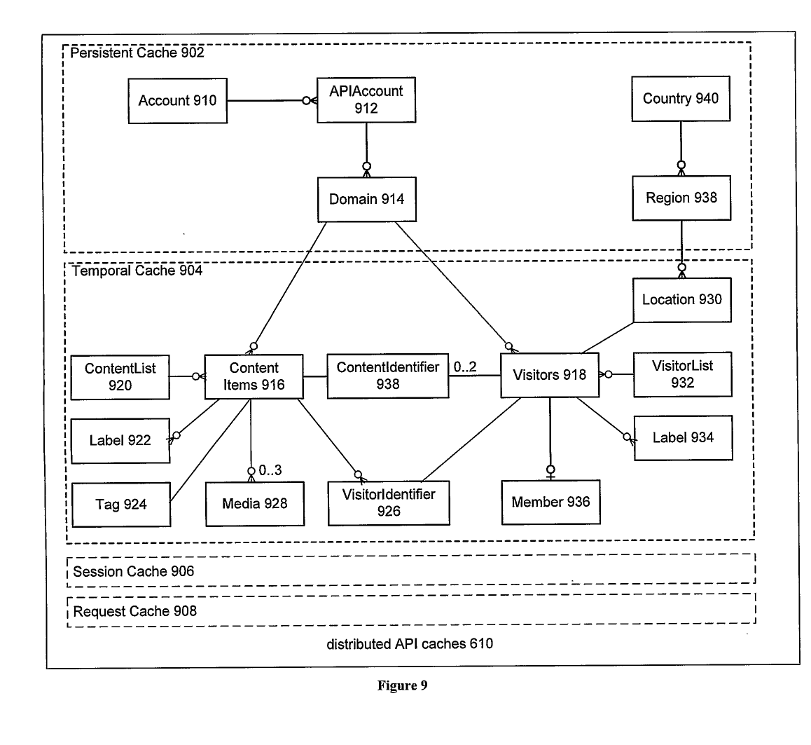

The distributed API caches 610 store data in four caches, shown in FIG. 9, for different types of data:
1. a temporal cache 904 used by the manager module 814 to store results for the real-time tracking (i.e. capture or usage) data that is used in the report data;
2. a persistent cache 902 for storing data for longer periods than in the temporal cache, and used by managers to store information retrieved from a persistent data source such as the RDBMS 222;
3. a session cache 906 used by the API server 218 to store authentication data of the at least one observer client 504 during an authenticated session; and
4. a request cache 908 used by the API server 218 to store formatted and/or compressed reports in response to service requests, e.g. recently requested usage reports for the observer client 504.

The persistent cache 902 includes account data relating to an account of at least one observer who has registered with the tracking system 100. A plurality of accounts or persons may be associated with a group API Account 912 which allows all members of the account access to the API server 212. A plurality of API accounts 912 are associated with each Internet domain which is tracked by the tracking system 100. Each domain 914 is associated with a plurality of content items 916 or media resources 604, and visitors 918. Data relating to content items 916 and visitors 918 are stored in the temporal cache 904. The temporal cache includes data relating to a list of current content items in a contentlist 920. Each content item 916 is associated with a plurality of labels 922 and tags 924, stored in the temporal cache 904. Each item of content 916 relates to a plurality of visitor identifiers, representing visitors who are using the media in the listed content items, listed in a visitor identifier list 926. Each content item in content items 916 has associated media data 928 and each associated visitor in the visitors 918 has an associated location listed in the location data 930, all of which are in the temporal cache 904. A list of all visitors 918 is stored in visitor list data 932, and each of the visitors 918 has one or more labels 934 which is descriptive of the visitor. Some visitors may be registered visitors in the tracking system 100, in which case a visitor of visitors 918 with the recognised account data also has a record in corresponding member data 936 associated with visitors 918. Each visitor of visitors 918 is related to a piece of content in the content items 916 by content identifier data 938 indicative of the media resource 604 being used by the visitor. The geographical location of each visitor, stored in the location data 930, relates to a region represented in region data 938, stored in the persistent cache 902 and representing a plurality of locations. Similarly, groups of regions in the region data 938 are represented by countries in country data 940 in the persistent cache 902.

In summary:
1. the Account data 910 contain data for authentication e.g. username and password;
2. the API Account data 912 are used for accessing the API Servers 214 as it contains an APIKey (a code for accessing the API Servers 214) that is necessary for authentication;
3. the Domain data 914 contain the store cluster identifier (e.g. the store cluster URL address) used to route the incoming requests to the correct store for information about that domain; the Domain data 914 also group what APIkeys have access to which domains;
4. the Country data 940 is a look up table for county names and codes;
5. the Region data 938 list cities or regions that are associated with counties;
6. the Location data 930 contain an indicator of the visitor's location (e.g. Internet Protocol (IP) address) that maps to a country and region;
7. the Content Items data 916 store information about the data the visitor is viewing;
8. the ContentIdentifier data 938 represent a composite key used to identify content relationships;
9. the Visitors data 918 represent a visitor using media content;
10. the Member data 936 represent a visitor, using media, who has identified themselves to the tracking system 100 (e.g. logged into a website, using a visitor account, to access a webpage), and includes custom information about the visitor imputed by the operator/manager of the media resource 604, such as age, gender, name, likes and dislikes, etc.
11. the VisitorIdentifier data 926 represent a composite key that is used to identify visitor relationships;
12. the VisitorList data 932 are used to group visitors for fast lookups, which is possible with a TreeList-type data structure;
13. the content list data 920 are used to group content for fast lookups, which is possible with a TreeList-type data structure;
14. the Media data 928 represent references to further media associated with the actual media resource 604, e.g. a thumbnail image of the content;
15. the Content Tag data 924 is a String that describes the media resource 604 (e.g. “music”, “video”, “pop”);
16. the Content Label data 922 is a String that describes the media resource 604 (e.g. “music”, “video”, “pop”), and is sent from the tracking module 602; and
17. the Visitor Label data 934 is a Visitor String that describes the visitor.

Store 228

The store 228 operates as a distributed memory for performing the following:
1. Storing visitor data and content data (i.e. data relating to the visitor and/or user data relating to the media resource or activity performed that is associated with the user 604);
2. Indexing and searching the stored data;
3. Sharing data between nodes 232; and
4. Handling faults without affecting other nodes or losing data.

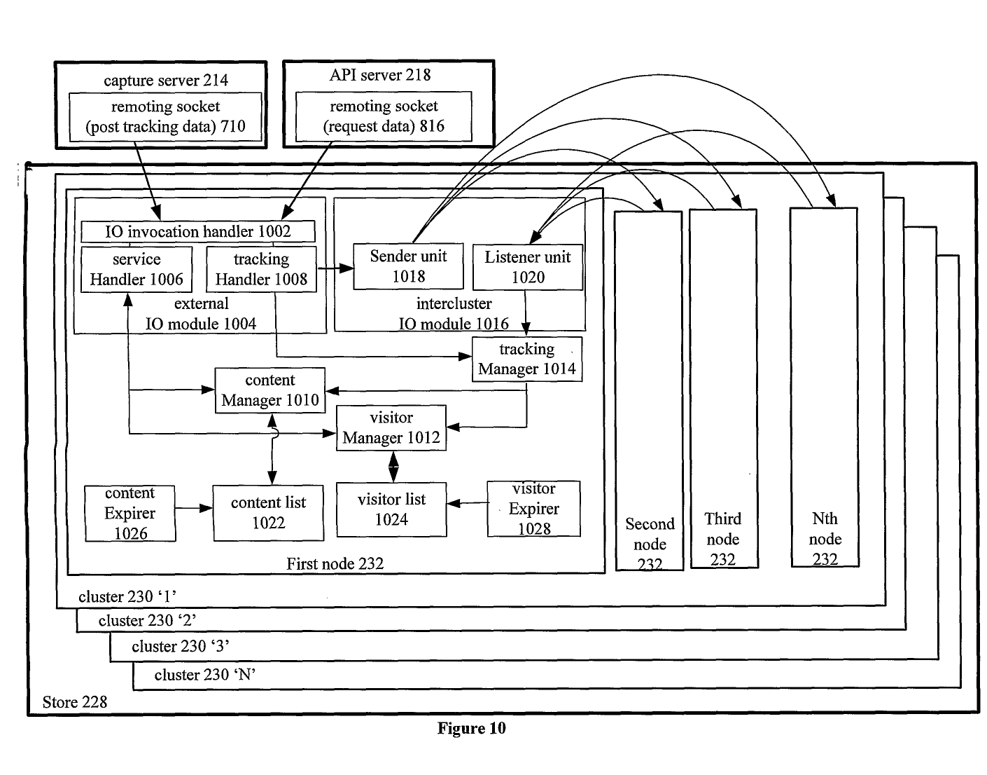

The store 228, in FIG. 10, is in communication with the capture server 214 and the API server 218, using their respective the network connections 710, 816, and an input-output (IO) invocation handler 1002. The invocation handler 1002 is part of an external input-output (IO) module 1004 of each node 232 of each cluster 230 of the store 228. The invocation handler 1002 is in communication with a service handler 1006 and a tracking handler 1008. The service handler 1006 is used to service report requests from the API server 218 and is in communication with a content manager 1010 and a visitor manager 1012 in the node 232. The tracking handler 1008 is used to receive and forward tracking or usage data from the capture server 214 and is in communication with a tracking manager 1014 and an inter-cluster input-output (IO) module 1016 of the node 232. The inter-cluster IO module 1016 is used to send and receive data between nodes of each cluster 230 using a multicast protocol. A sender unit 1018 of the inter-cluster IO module 1016 receives newly arrived tracking/usage data from the tracking handler 1008 and sends this newly arrived tracking/usage data to all nodes 232 in the cluster 230. A listener unit 1020 in the inter-cluster IO module 1016 receives multicast, transmitted data from the other nodes (of nodes 232) in the cluster 230 and sends it to the tracking manager 1014 of the particular node (of nodes 232). The tracking manager 1014 receives the tracking/usage data from the tracking handler 1008 and the listener unit 1020 and sends it to the content manager 1010 and the visitor manager 1012.

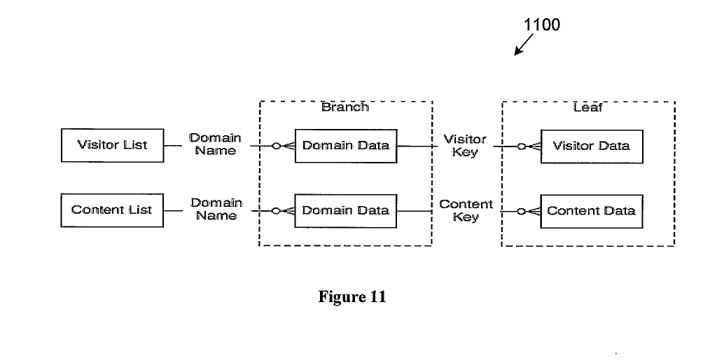

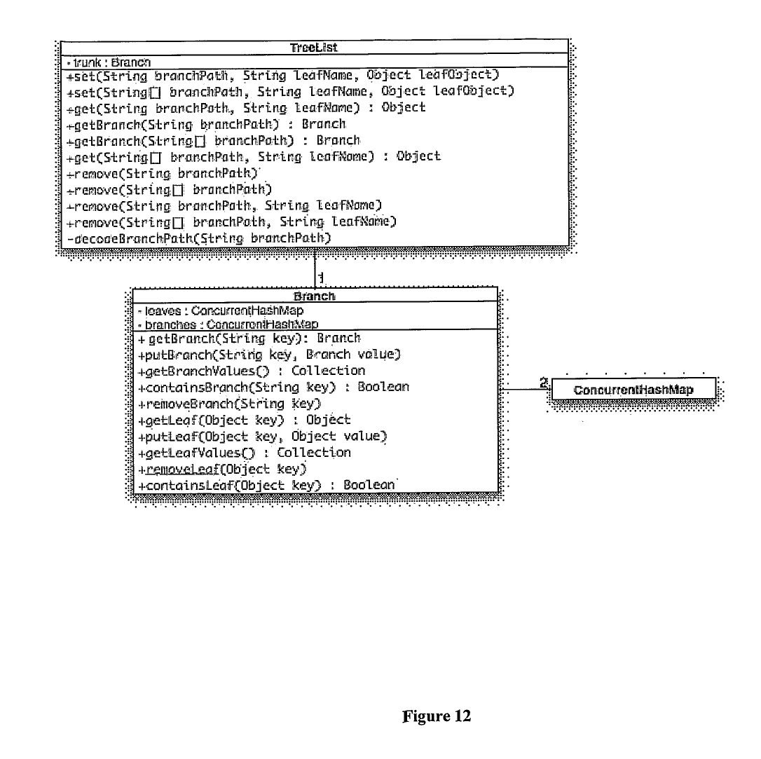

The content manager 1010 receives content data, relating to the media resource 604 being used by the visitor, and stores this data in a content tree list structure 1022, shown in FIGS. 11 and 12. The content manager 1010 also retrieves content data from the content list structure 1022 for transmission to the service handler 1006 for sending to the API server 218 in response to a report request. Analogously to the content manager 1010, the visitor manager 1012 maintains data about the visitors, including visitor profile data, in a visitor list 1024. The visitor manager 1012 stores data in the visitor list 1024 and retrieves data from the visitor list 1024 for transmission to the service handler 1006 in response to a report request.

The content list structure 1022 is in communication with a content expirer 1026 for removing data from the content list structure 1022 that is no longer relevant. The visitor list 1024 is in communication with a visitor expirer 1028 for removing data from the visitor list 1024 that is no longer relevant, e.g. has not been used for a certain period of time.

Data Arrangements

Usage data (i.e. content/activity and visitor/user data), stored in the store 228, are stored in data structures that are the same as those in the distributed API caches 610, described above with reference to FIG. 9. Processed “report” data is stored in the distributed cache 610. The visitor and content data (i.e. usage data) being tracked is stored in the treelist structure 1022 on each store node 232.

The content and visitor data in the content list structure 1022 and the visitor list 1024 are stored as shown in the data entity relationships 1100 in FIG. 11. Each visitor list 1024 is divided into a number of branches 1102, where each branch relates to a network domain of the visitor (i.e. related to the domain in domain data 914), which is the domain that the visitor is visiting (e.g. viewing or accessing). Each branch 1102 in the visitor list 1024 has a plurality of associated leaves 1104, each containing data relating to an individual visitor. Similarly, the content list structure 1022 has a plurality of branches 1102 relating to network domains of each media resource 604, and each domain has a plurality of leaves 1104 each with content data relating to an individual media resource 604. These data structures are known as a “TreeList”. The TreeList configuration allows for 2,147,483,647 child branches and leaves, which allows for further levels of categorisation and partitioning of data beyond the two levels shown. The data in the two TreeLists, i.e. visitor list 1024 and content list structure 1022, are decoupled, and contain no references to each other, which reduces difficulties of transferring large data objects over a network (e.g. between data centres).

Each node 232 has a full copy of the usage data tracked since the corresponding cluster 230 has been active in the tracking system 100. A new node 232, when included in a particular cluster 230, is populated with all data from the other nodes by the UDP multicast, which occurs periodically as controlled by the store 228.

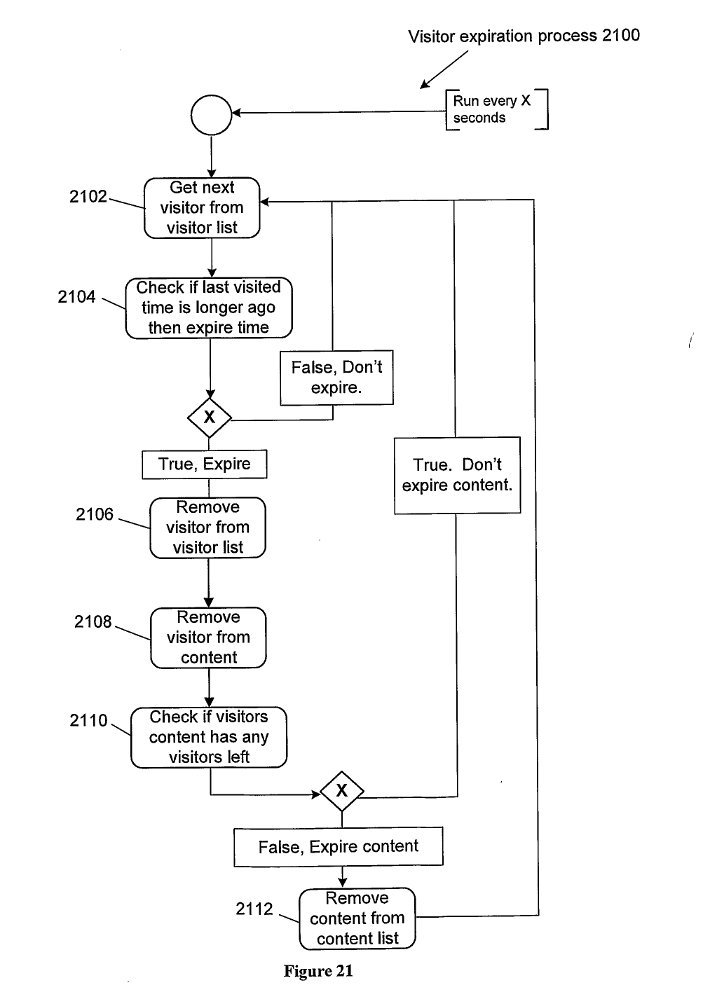

The expirer process is performed by each node 232 after a preselected period of seconds, e.g. every five or every ten seconds, as described in more details below with reference to FIG. 21. The TreeList data is no longer relevant if the visitor has not sent a tracking request for a predetermined period of time, e.g. ten or twenty seconds. Content data is no longer relevant when no visitors are currently viewing or using the corresponding media resource 604.

FIG. 12 shows a class diagram of the TreeList demonstrating the code that makes the TreeList. The data in the store 228 is stored as Java Objects.

Processes

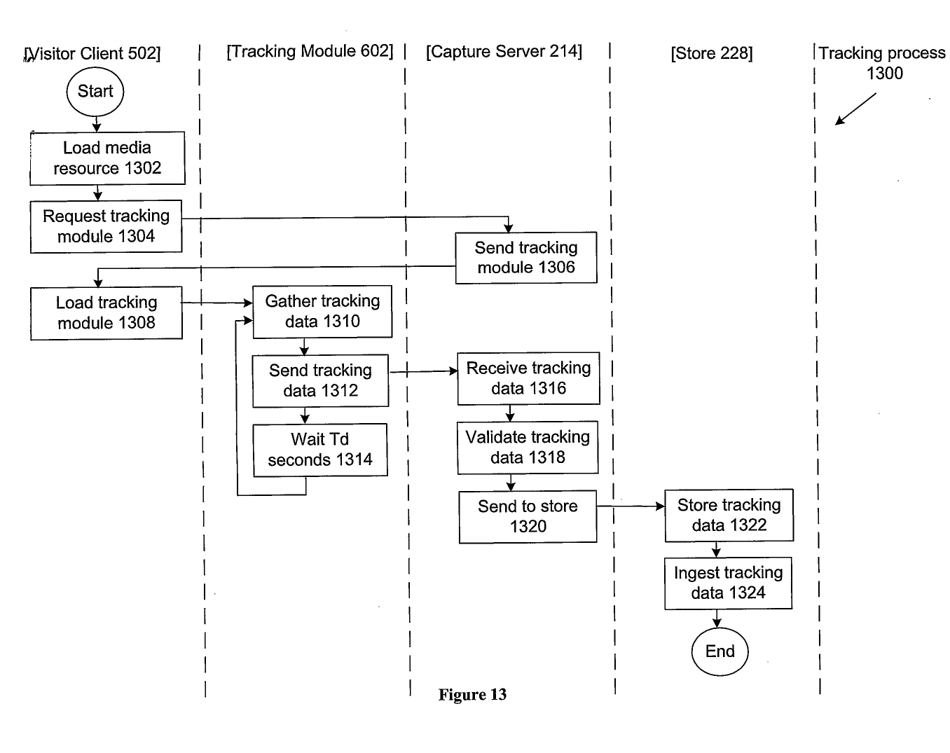

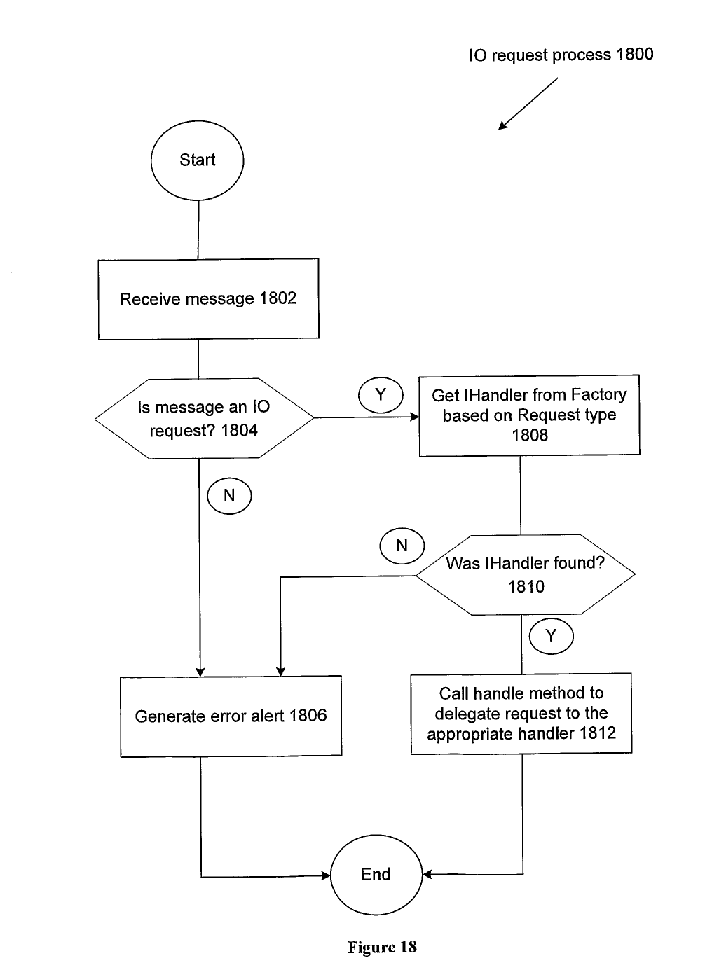

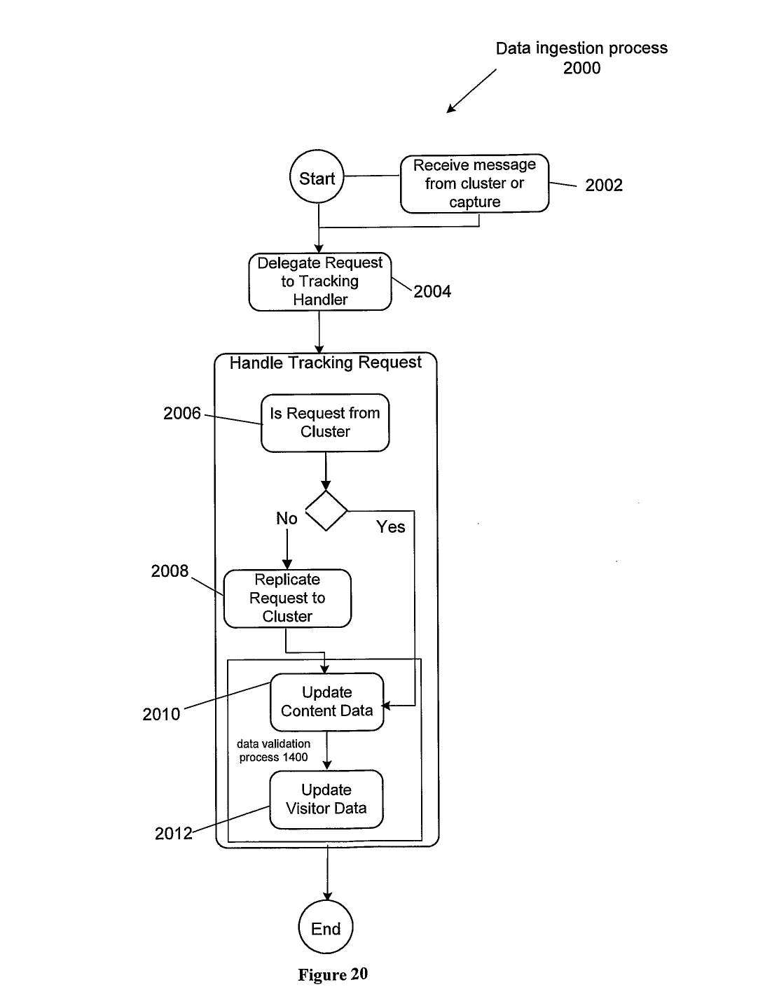

In order to gather usage data relating to media use, the tracking system 100 performs a tracking process 1300, in FIG. 13, which is initiated by the visitor client 502 loading or receiving the media resource 604 (step 1302). The media resource 604 has a tag or reference relating to the location of the tracking module 602, which is recognised by the visitor client 502, and the visitor client 502 then consequently requests the tracking module 602 from the capture server 214 (step 1304). The media resource 204 reference (e.g. URL) identifies the location of the tracking module 602 served by the capture server 214. The visitor client 502 uses the tag, or reference, to download the tracking module 602 from that location and run it. In response to this request, the capture server 214 sends the tracking module 602 to the visitor client 502 (step 1306), which then loads the tracking module 602 (step 1308), thereby activating the tracking. Once activated, or run, the tracking module 602 gathers the tracking data, or the usage data, from the visitor client 502 relating to the content (i.e. the media resource 604) and the visitor of the visitor client 502 (step 1310). Once all relevant data fields, listed in Table 1, are filled by the tracking module 602, the tracking data is sent to the capture server 214 (step 1312). After sending the tracking data, the tracking module 602 waits for a preselected period of delay time, e.g. “Td” seconds where Td is five or ten (step 1314), before repeating step 1310 for gathering the tracking data. The tracking module 602 continues to repeat the gathering and sending steps (1310 and 1312) until the tracking module 602 is deactivated by the visitor client 504 by no longer using the media resource. When the tracking data is received by the capture server 214 (step 1316), the capture server 214 validates the tracking data in a tracking data validation process 1400 (step 1318). The validated tracking data is sent by the capture server 214 to the store 228 (step 1320). The store 228 stores the received validated tracking data (step 1322) using an input-output (10) request process 1800 (described below with reference to FIG. 18). The received tracking data is ingested, or stored, by each node of the nodes 232 in the relevant cluster 230 (step 1324) in a data ingestion process 2000 (described below with reference to FIG. 20).

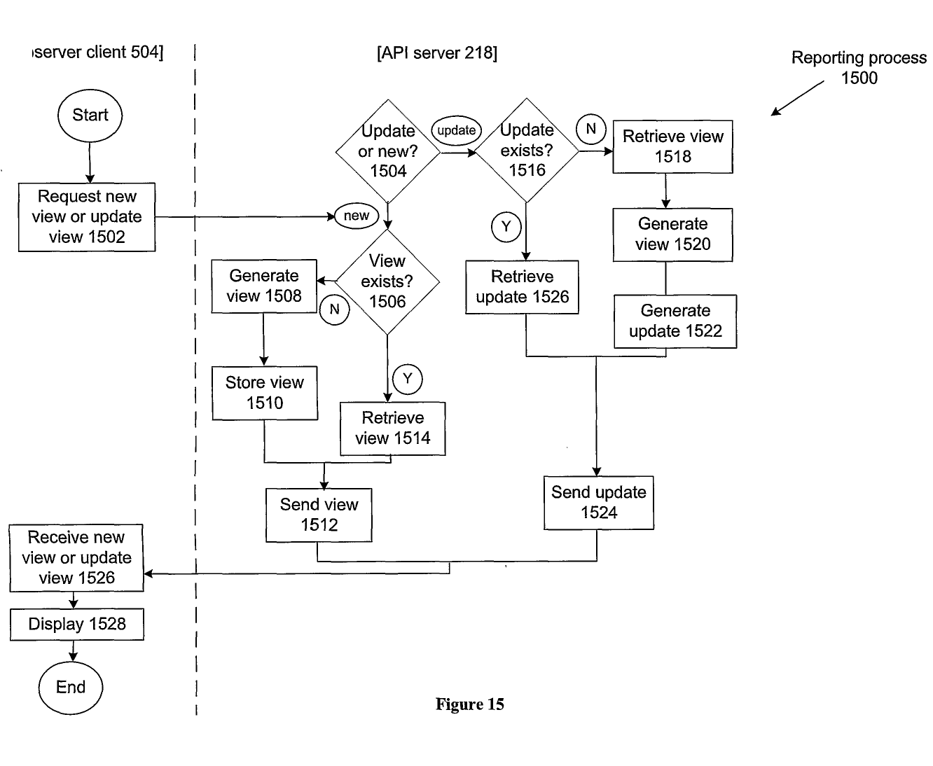

The observer is provided with reports on current, up-to-date and real-time media usage, which are referred to as “views”, in a reporting process 1500, as shown in FIG. 15, performed by the tracking system 100. The reporting process 1500 commences with the observer client 504 requesting a new view, or requesting an updated view (step 1502), e.g. one of the views shown in FIGS. 22 to 41. A new report or “view” is a representation of the content and what visitors are viewing them at that point in time, whereas an update view is a representation of what has changed regarding the content and visitors since the last view or update was received. The API server 218 receives the request and determines whether an update or a new view is required (step 1504). If a new view is required, the API server 218 determines whether this view already exists (step 1506), by accessing the reports listed in the distributed in the API caches 610, and their views, and comparing them to the requested view. If the view does not exist, the API server 218 generates the view (step 1508) based on data in the view request, including the current content that is being viewed and the visitors that are viewing them. Once the new view is generated, a copy is stored in the data store 228 (step 1510), and the view is sent by the API server 218 to the observer client 504 (step 1512). An example of XML data representing a new view is the “Community View” code shown in the Appendix. If it is determined that the view does exist, in step 1506, the view is retrieved from the store 228 (step 1514) and send to the observer client 504 in step 1512. If it is determined that the request is for an updated view, in step 1504, the API server 218 determines whether an updated view already exists based on updated view report data in the distributed API caches 610 (step 1516). An example of the XML data representing an updated view, including a new visitor, is the “Community Update” code shown in the Appendix. If an update to the view does not exist, a new one is requested from the store 228 by the API server 218 (step 1518), and a view is generated by creating a new representation of the content and visitors; this is done by examining the content and visitor lists 1022 and 1024 and building up a report on the data contained within them (step 1520). From the generated view the Store 228 generates an updated view (step 1522). Once the update view has been generated, the API server 218 sends the update view (step 1524). If it is determined that the update already exists, in step 1516, the API server 218 retrieves the update from the store 228 (step 1526) and sends it to the observer client 504 in step 1524. The observer client receives the new view, or the update view (step 1526) and displays the new or updated view or “report”, to the observer using the observer client device 110 (step 1528).

Examples of report data formatted as XML for sending from the API server 218 to the observer client 504 are shown in the Appendix, including information about a specific item (a particular web page), information about a visitor to a web page, and overview information about all visitors and items in a community (specifically the number of members, visitors and content items in each domain).

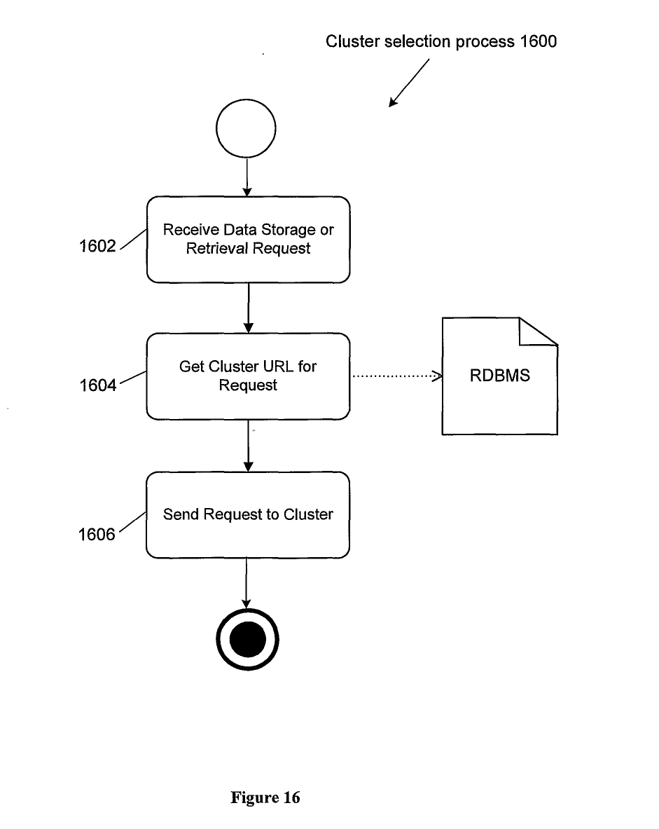

Each Store cluster 230 in the store 228 is referenced by a unique cluster code, or identifier (ID), in the form of a cluster domain identifier. Each cluster 230 stores data relating only to a single domain, or range of domains, not stored by the other clusters. When accessing the store 228, the capture server 214 and the API server 218 both use a cluster selection process 1600, shown in FIG. 16, in which the store 228 receives a data storage request, e.g. to store tracking data from the capture server 214, or a retrieval request, to retrieve reporting data for the API server 218 (step 1602). When this request has been received, the corresponding server 214, 218 accesses the RDBMS 222 to retrieve the cluster identifier relating to the data request (step 1604); the cluster identifier is selected by matching the network domain of the content data being stored, or retrieved, with an identification code of its uniquely corresponding cluster of the clusters 230. Once the corresponding cluster 230 is identified, the storage or retrieval request is sent to that cluster 230 (step 1606).

This cluster selection process 1600 provides data segmentation which allows the large amounts of data in the store 228 to be divided, or split up, into more manageable and easily stored segments. The data in the store 228 is split up based on the domain name of the content relating to the media resource 604 being used by the visitor. Each cluster 230 may then be customised based on the traffic requirements associated with each domain name. Each cluster 230 is configured in an analogous manner, and has no stateful knowledge of the stored data (i.e. no relating state data is stored), and thus hardware associated with each node 232 may be moved between logical clusters 230. In an example look-up request, a request is made by the observer client 504 for a report relating to the domain name “acme.com”. The API server 218 first looks up the domain name in the RDBMS 222 and receives a unique cluster identifier in the form of a cluster universal resource locator (URL) ‘store2.mystore.com’. Once the API server 218 has the cluster URL, it proceeds to contact the cluster directly.

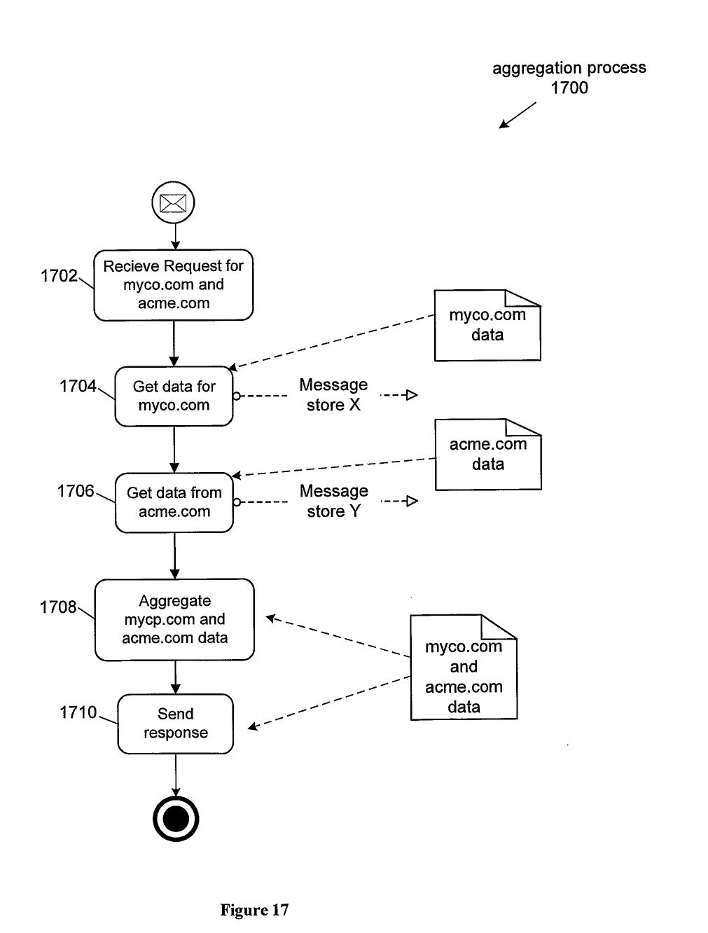

When retrieving data from the store 228, the API server 218 may need to access data relating to more than one cluster 230, e.g. when report data is required relating to a number of different network domains. The domain or domains of interest are specified in the request data sent by the observer client 504. For requests that require usage data from a plurality of clusters 230, the API server 218 aggregates the data into a single reporting message, or response, before sending it to the observer client 504, using an aggregation process 1700, shown in FIG. 17. For example, the API server 218 receives a request for data relating to “myco.com” and “acme.com” (step 1702). The API server 218 first retrieves data relating to “myco.com” (step 1704), then retrieves data relating to “acme.com” (step 1706) and then aggregates the data into a single data record (step 1708) before sending the aggregated response to the observer client 504 (step 1710).

Store Processes

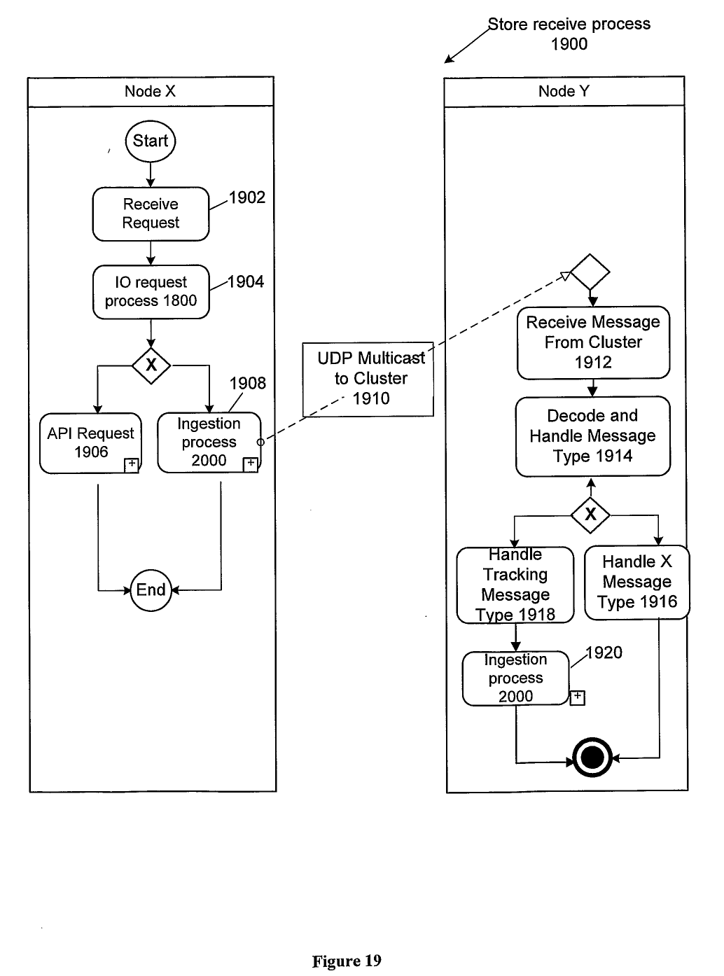

In a store receive process 1900, as shown in FIG. 19, a node “x” of the nodes 232 in a particular cluster 230 of the store 228 receives a data request (step 1902) and processes it through the IO invocation handler 1002 in an input-output (IO) request process 1800. Once a message has been processed by the IO request process 1800 in step 1904, it either enters a data ingestion process 2000, shown in FIG. 20, for a tracking data request from the capture server 214, or it enters an API request process (step 1906) for non-tracking data messages. For usage data delivered from the capture server 214, the usage data is ingested by the node into its internal memory in a data ingestion process 2000 (described below with reference to FIG. 20), and then the data is transmitted to all other nodes in the cluster using an UDP multicast protocol (step 1910). Each other node 232 in the particular cluster 230, including node “y” receives the message via UDP multicast (step 1912) then decodes and handles the message in another IO request process 1800. Once the message has been received by the cluster message receiver, it is passed into the same ingestion process as the IO requests (step 1914). Once processed in step 1914, tracking data messages are identified (step 1918) and ingested by node “y” in its data ingestion process 2000 (step 1920). Non-tracking data messages (i.e. “X” message types) are processed in a ‘Handle X Message Type’ process (step 1916).

The IO invocation handler 1002 of the store 228 performs the input-output (IO) request process 1800, shown in FIG. 18, when it receives a data message (step 1802) from the capture server 214 or the API server 218. The invocation handler 1002 determines whether the received message is an input-output (IO) request (step 1804). If the message is not an IO request, then the message is ignored, and/or an error alert is generated (step 1806). If the message is an IO request, determined in step 1804, the relevant “IHandler” is retrieved from a “Factory” based on the type of request, e.g. a message with tracking data from the capture server 214 or a request for report data from the API server 218 (step 1808): the “Factory” knows what handler to use to handle the IO request based on a type parameter that is passed as a part of the IO request. Once the Factory has returned the correct handler for the type of IO request, the IO request is then passed to the handler to be processed. The “Factory” approach is used so that new message types can be added easily by just adding them to the Factory. The invocation handler 1002 determines whether the appropriate IHandler has been found (step 1810), and if not an error alert is generated in step 1806. If the relevant IHandler is found, as determined in step 1810, the corresponding handler method is called to delegate the request to the appropriate handler of the two handlers, service handler 1006 and tracking handler 1008 in the external IO module 1004 (step 1812).

The data ingestion process 2000, performed by each node 232, commences when the node receives a message from elsewhere in the cluster or from a capture server (step 2002). The request is delegated to the appropriate tracking handler, either service handler 1006 or tracking handler 1008, (step 2004) which then determines whether the current message/request is from within the cluster, i.e. is a UDP multicast from a neighbouring node 232 (step 2006). If the message is not from a cluster, it is replicated to the other nodes 232 in this particular cluster 230 via a UDP multicast (step 2008). Once the message has been replicated in step 2008, or if the request was already received from within a cluster, determined in step 2006, the content data relating to the media resource 604 in a message in the store 228 is updated by accessing the content list 1022 by the content manager 1010 (step 2010), and the visitor data corresponding to the visitor is updated in a similar manner (step 2012).

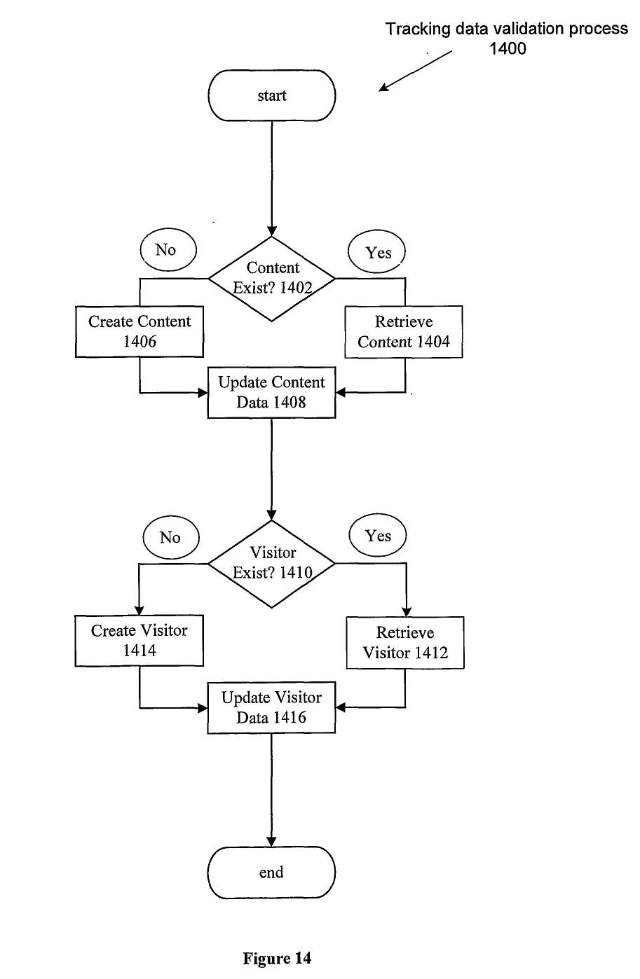

The tracking data validation process 1400, in FIG. 14, is performed by the store 228 and commences by determining whether a copy of the content relating to the media resource 604 exists in the store 228 (step 1402) by checking visitor tree list 1024 and the content tree list 1022. If the content does exist, it is retrieved from the store 228 (step 1404), and if the content does not exist, it is created by making new data objects and transferring into them the captured usage data from the capture server 214 (step 1406). Once retrieved or created in steps 1404 or 1406, the content is updated in the store 228 (step 1408). Once the content data has been updated, the visitor data is updated by first determining whether a copy of the visitor relating to the media resource 604 exists in the store 228 (step 1410). If the visitor does exist, visitor data are retrieved from the store 228 (step 1412), and if the visitor data does not exist, it is created by making new data objects and transferring into them the captured usage data from the capture server 214 (step 1414). Once retrieved or created in steps 1404 or 1406, the visitor data is updated in the store 228 (step 1416). The tracking validation process 1400 finishes when the content data and the visitor data have been updated.

In parallel to the data ingestion process 2000, a visitor expiration process 2100, in FIG. 21, is performed, or run, by the visitor expirer 1028 on data in the content list structure 1022 and in the visitor list 1024. The expiration process 2100 is run after a selected certain time, e.g. “Te” seconds, e.g. every five or every ten seconds. The visitor expiration process 2100 commences by getting, or receiving, data representative of the next visitor from the visitor list 1024 (step 2102), and then checking if the last visitor time is longer than a preselected visitor expiry time, e.g. ten seconds or thirty seconds (step 2104). If the last visit time by the selected visitor is less than the expiry time, the visitor expiration process 2100 returns to wait for another Te seconds or repeats the process with the next visitor in the list. If the visitor has not visited for a time longer than the visitor expiry time, the visitor is removed from the visitor list 1024 (2106), and the visitor is removed from the content list structure 1022. The content expirer 1026 then checks whether the content from which this visitor was recently removed, has any visitors left (step 2110), and if no visitors are left, the content is removed from the content list (step 2112).

In a content expiration process, the content expirer 1026 removes any content that has no visitors. This is a separate process and does not get called by the visitor expirer. The content expiration process is performed, or run, every “Te” seconds, e.g. every five or ten seconds.

Reports

The observer client 504 generates reports, or ‘views’, to provide a graphical user interface (GUI) on the observer client device 110, using the report data generated by the API server 218. The reports are displayed to the observer for providing the real-time or stored usage or activity data in a variety of selective formats that enable the data to be easily interpreted and compared.

A basic view 2200, in FIG. 22, includes:
1. a Logo & Header display 2202 for placement of a logo and header information, e.g. logins, current date, etc);
2. a Main Navigation Bar display 2204 containing the following navigation controls:
   a. a My Views control 2206 to generate default displays to present the observer (user) with a view that they have previously created and have set as their default, which is the default page selected when the application is launched; other created views can be accessed via the My Views drop-down menu; in the event that a view has not been created, the user will be encouraged to begin using the application by creating a new view,
   b. a Domains/Pages/Tags control 2208 that provides the observer (user) with a complete view of all their domains, pages or tags, i.e. their content,
   c. a Manage Views control 2210 that provides the observer (user) with options to manage the views that they have created; for example, the observer may edit the filters selected for a particular view or set another view as the default, and only one view may be marked as the default view at a given time,
   d. a Settings control 2212 that provides the observer with a list of application setting, and
   e. a Help control 2214 for displaying help files and mini-tutorials;
3. a Create Content Filter control 2216 that allows the observer (user) to create a filtered view of their selected usage data by dragging and dropping items into this space from a content selector panel 2220;
4. a Main Content Area 2218 that presents the content of their section; the content within this area expands to adapt to the total amount of space available in regards to the size of the create content filter bar;
5. the Content Selector Panel 2220 which displays all content items grouped into categories, e.g. domains, pages or tags, which are items used to create a content filter by dragging items onto the create content filter panel; and
6. an Additional View Options 2222 which presents the observer (user) with additional options in regards to viewing the content displayed in the main area, which include:
   a. a Graph Type control 2224 that allows the observer (user) to change the type of graphs used within the content area to display the retrieved data, and available options are presented to the user via a drop-down menu of available graph types,
   b. a Zoom In/Out control 2226 that allows for the content within the main content area to be zoomed in and out; when this option is selected the cursor changes to a magnifying glass to allow the observer (user) to zoom into specific locations of content,
   c. a Grab control 2228 for grabbing sections of the screen,
   d. a Full Screen control that presents the information in the main content area in full screen, smoothly, and
   e. a Save View control 2230 that allows the observer (user) to save the current view of the data being shown within the main content area as well as the selected filters; the user has the option to set the saved view as the default view when they launch the application.

A content filter 2234 in the Create Content Filter view allows the observer to create a customised ‘visual’ filter based on their available data. The observer can drag items from the right-hand selector panel 2220 and drop them into the filter space 2234 to create a group of filtered items. Properties by which the main body of data can be filtered are specific to certain domains, pages and tags.

Filtered Content Items are displayed in the Content Filter view, and comprise of three items: domains, pages and tags. Each of these items is visually represented in a unique fashion to allow for quick user interpretation, e.g. a Domain is represented by a thumbnail with a second layer behind it, Pages are represented by a thumbnail with a corner fold, and Tags are represented textually. When a domain is selected all its related pages residing within the pages tab are selected as they will be part of the domain. These subsequent pages do not appear within the filter.

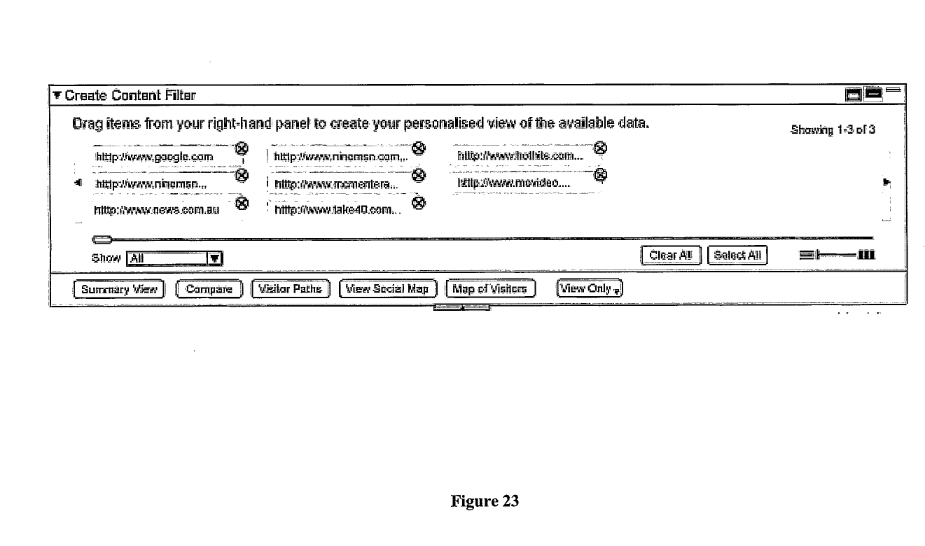

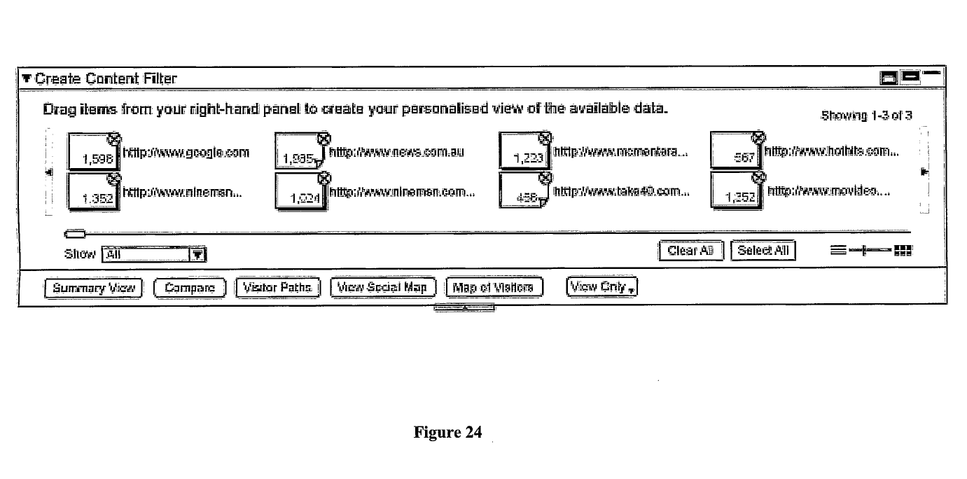

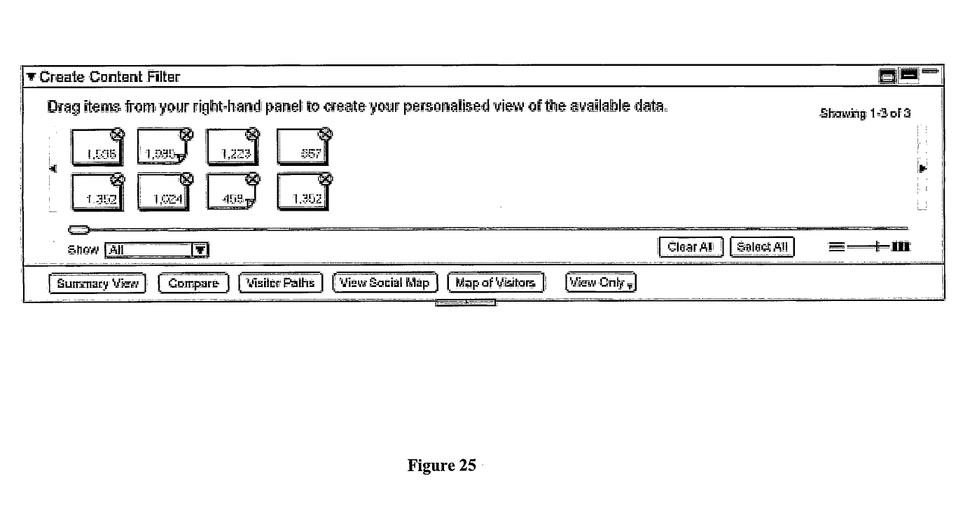

The content filter is capable of displaying its information, i.e. observer/user-defined filters, in a various number of ways. These different modes adopted by the content filter are called views. These views can display user-defined filters in formats such as thumbnails to list views, including:
1. a list view, in FIG. 23, provides a text only representation of each item, tags remain the same as they are represented in textual format, and domain and pages are represented by their URL;
2. a list and thumbnail view, in FIG. 24, combines a preview of the content along with their textual representation, thus domains and pages are represented by a small image along with their URL, while tags are represented in a textual format;
3. a small thumbnail view, in FIG. 25, displays the domain/page along with its total number of visitors will be displayed (the URL of the item is displayed by hovering over the thumbnail), while tags are represented in a textual format; and
4. a large thumbnail view (not shown) is similar to the small thumbnail view but each thumbnail is larger.

The content selector panel 2220 represents all the observer's preselected domains, pages and tags (i.e. ‘content’ for monitoring), each of which can be used in conjunction with each other to produce a customised filter. The content selector panel 2220 includes a quickfind control 2236 which presents the user with the option to quickly perform a search within the selected content type, e.g. domain. Matching results are displayed within the selector panel 2220 itself.

In creating a content filter, items must be selected from the selector panel 2220, in one of two ways:
1. a click to select process where items are selected by simply double clicking on an item, and multiple items can also be selected by individually double clicking on multiple desired items; or
2. a click & drag process where items are selected by clicking the mouse and holding it down while drawing a box around the desired object(s), and the selected objects can then be dragged and dropped into the content filter.

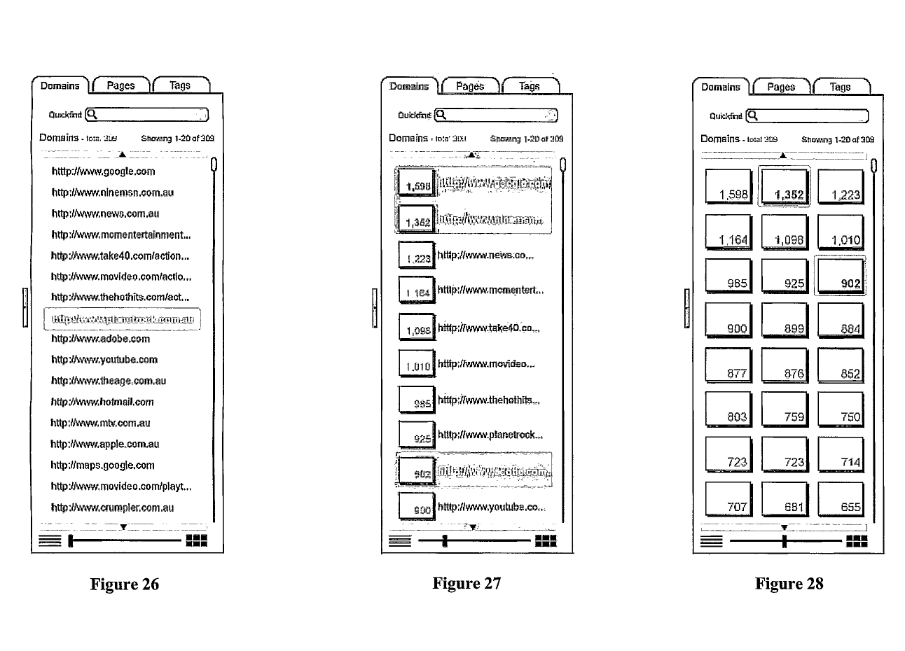

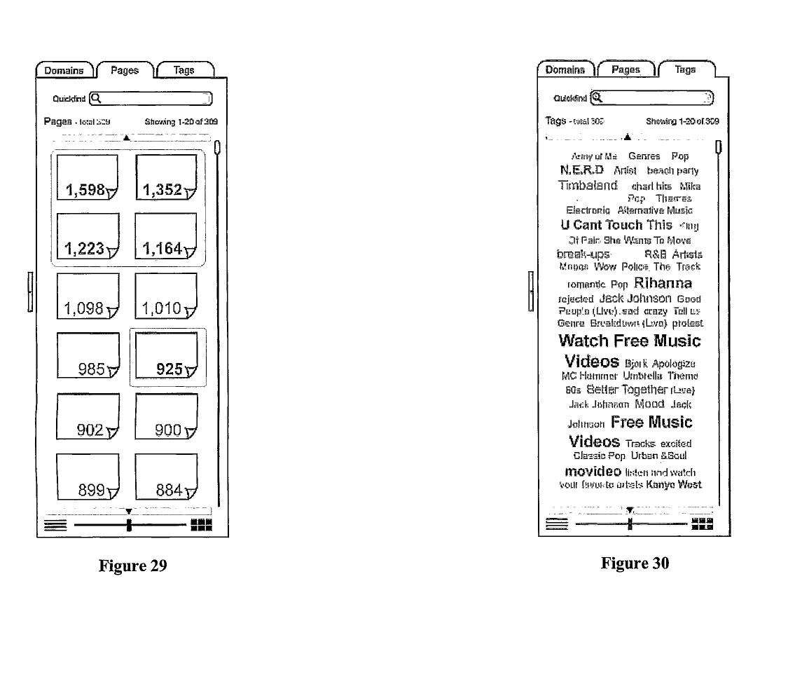

In a manner similar to the content filter views, various views are available of the selector panel 2220, including: a List Only view, in FIG. 26; a List & Thumbnails view, in FIG. 27; a Small Thumbnails view, in FIG. 28; a Medium Thumbnails view (not shown); a Large Thumbnails view (not shown); a Pages view, FIG. 29; and a Tags view, in FIG. 30, in which tags (or labels) are represented in a textual format and therefore have no options available for changing its view state, and the tags are presented textually and are visually treated to indicate how popular specific tags are, e.g. using the size and colour of the textual items.

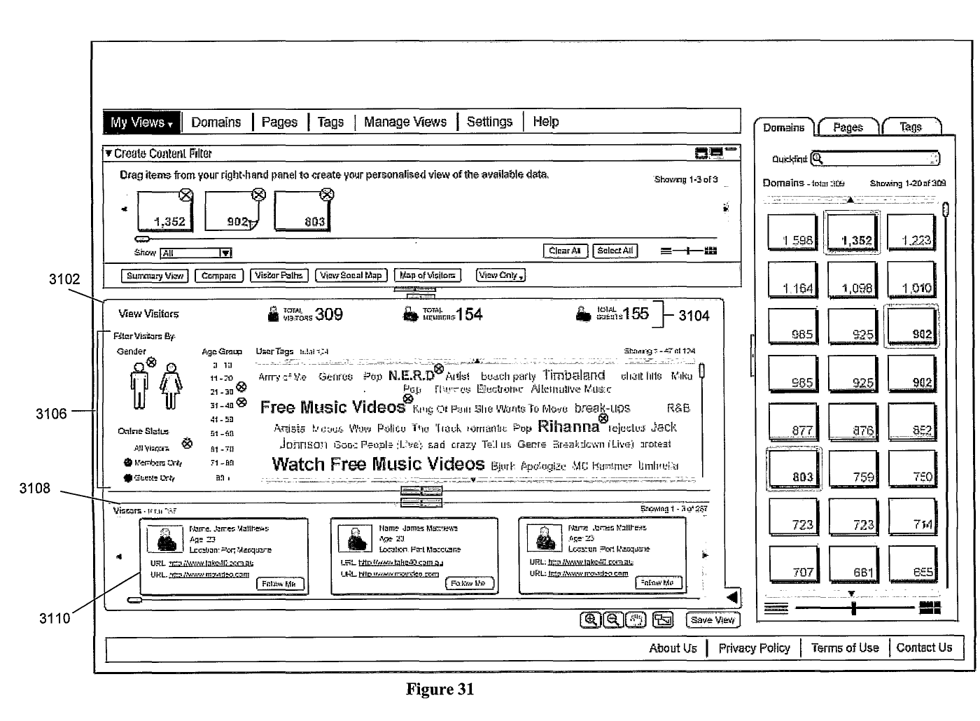

The visitor filter 3102, in FIG. 31, provides the observer (user) with the ability to define a customised filter based on the profiles of visitors who are actively connected to the filtered content. The visitor filter includes:
1. a Summary Section 3104 informs the observer (user) of the total number of visitors currently present on the filtered content, and represents the following totals: the total number of visitors (members+guests), the total number of content registered visitors currently logged in, and the total number of visitors simply visiting the content; and
2. a ‘Filter Visitors By’ filter 3106 allows visitors to be filtered by their gender, online status (that operates by the nature of which the visitor is connected to the piece of content: by Members Only, i.e. visitors that have registered to become members of a piece of content and have logged in; or Guests Only, i.e. visitors that are simply visiting the content and have not logged in whether or not they have registered as a member of that piece of content), age group and media content tags (i.e. defined in relation to the media resource 604).

The Visitors section 3108 provides the observer with information about all the visitors that are currently visiting the filtered content and that satisfy all visitor filters if applicable. The Visitor Profile Card 3110 presents the observer with a summary of information and details about the visitor. Each visitor regardless of their online status will be represented by a visitor profile card. This profile card also allows for the option to follow the movements of the visitor in real-time. This can provide a comparison between the visitor's historical data, and if online, the visitor's real-time usage data.

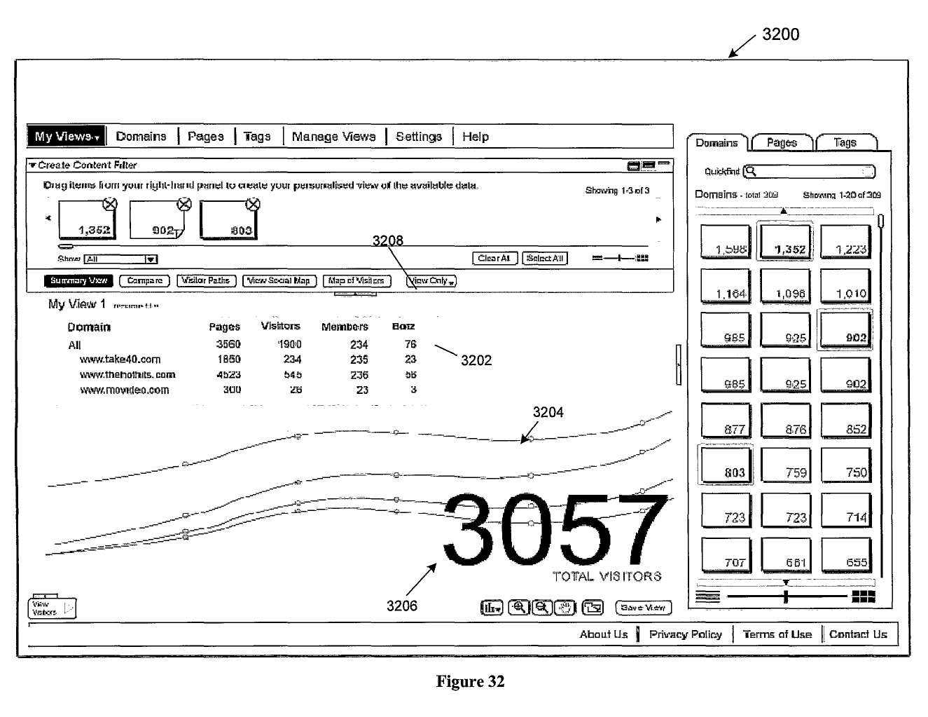

A Summary View, in FIG. 32, provides an overall view of the data as defined by the content filters populated by items within the selector panel 2220. This overall view provides the observer with a combined view of the data ranging from tabular to graphical data representations. A Data Table 3202 represents information accumulated and acquired on a real-time basis, including the total number of visitors, members, etc. A Graphed Data Display 3204 represents the data displayed within the data table in a graphical format, e.g. a graph representing visitors over time will dynamically adjust and change in shape to model the real-time figures acquired for the total number of visitors currently visiting the filtered content. The graph, by presenting historical stored usage data, can provide a comparison between the real-time data and the data accumulated previously over time in a single view. A Visitor Total display 3206 shows the total number of visitors currently visiting the filtered content.

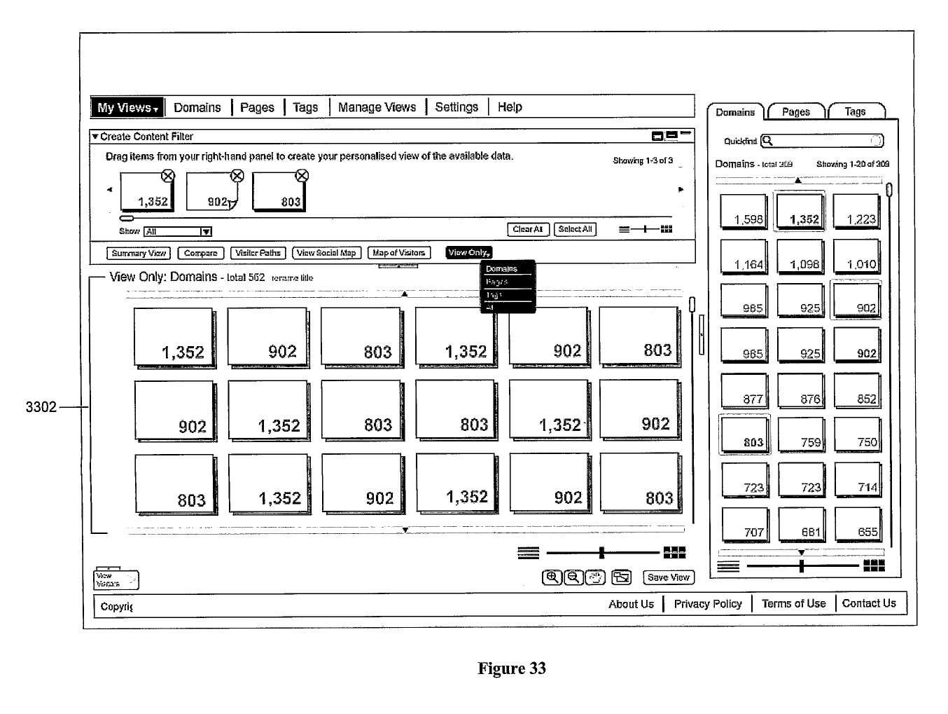

A View Only control 3208 allows the observer to view information and data about one specific type of content only, e.g. domains that they have placed within their filter, in a View Only: “X” view 3302, as shown in FIG. 33, where “X” may be “Domains”, “Pages”, “Tags” or “All” (i.e. all types of content).

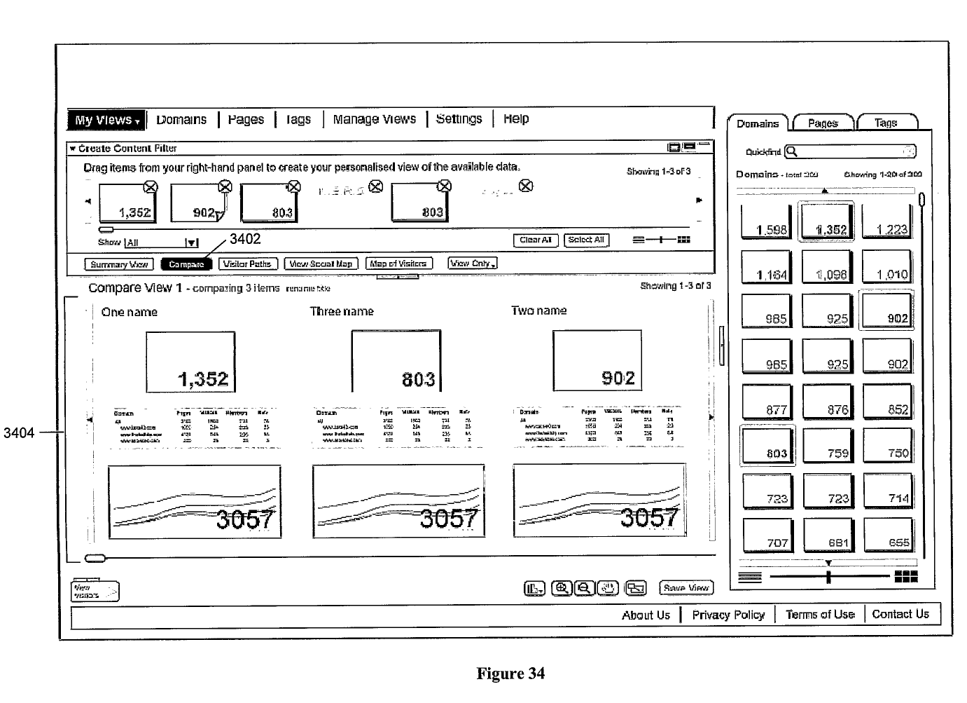

A compare control 3402 allows two or more pieces of content to be compared against each other in a Compare View 3404, in FIG. 34. Information that is common between the selected items is shown together for comparison. The items are shown in column format with a maximum of three items being shown at a given time. Only domains and pages can be compared. Items that have been selected for comparison are displayed severally within vertical Item Panels. The information presented can be based on processing usage data that is real-time data, stored historical usage data or a combination of both. A comparison can be provided between the historical and the real-time data in a single view.

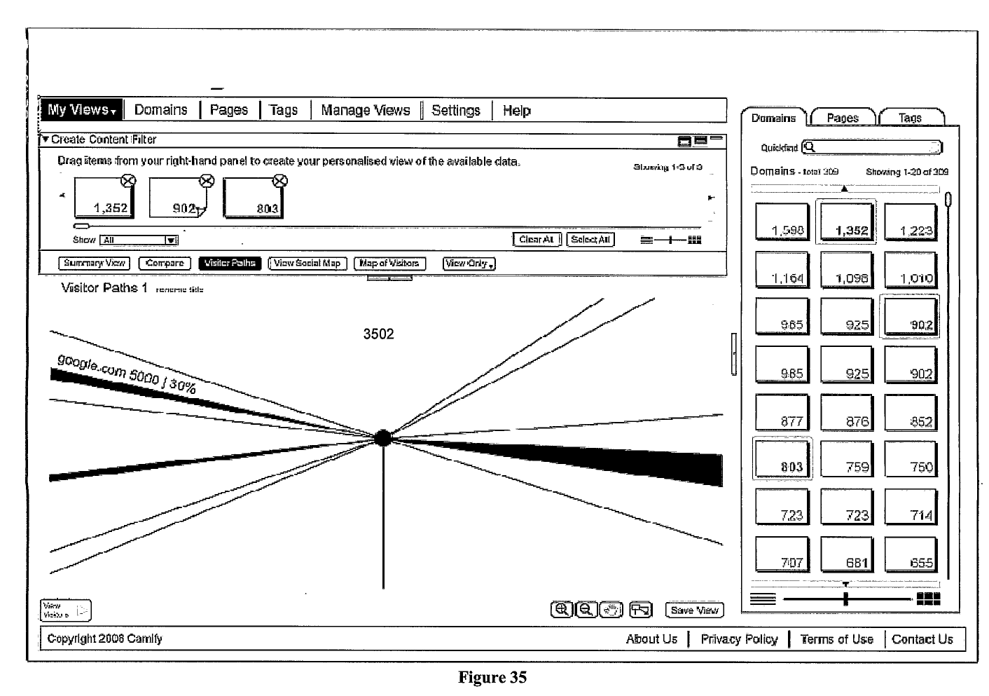

A Visitor Paths display 3502, in FIG. 35, visually depicts the originating source of content that the visitor used to access the items that the observer has placed within their filter. That is, this page illustrates where the visitor came from to access the filtered content. This information includes where visitors have come from and a total of how many. The Visual Paths display 3502 also shows outgoing information, i.e. where users have gone once they have left the filtered content. This information dynamically changes as new visitors arrive and depart from the content filter of domains/pages/tags. The usage data is recorded as it is captured so the dynamic view can be replayed at varying speeds to provide a comparison and analysis of historical data as well as real-time data.

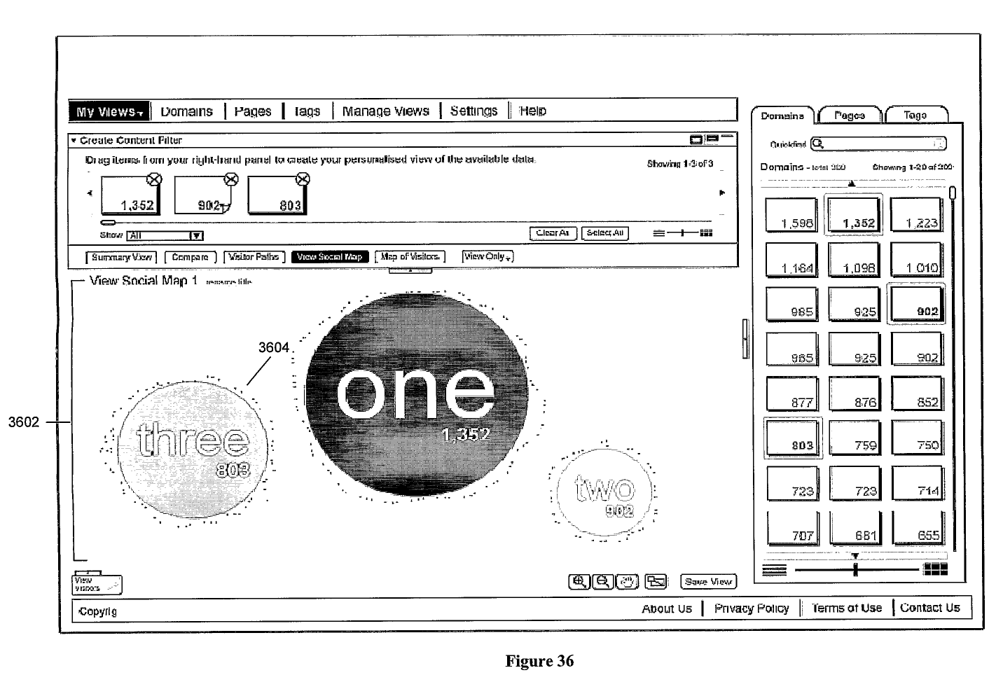

A Social Map view 3602, in FIG. 36, represents each individual item added to the content filters with an object (e.g. sized shape 3604), where each object is a representative of the number of total number of visitors currently visiting each content filter. This view also provides information regarding the movement of these visitors to and from the various content filter items. This information dynamically changes as new visitors arrive and depart from the collective filter of domains/pages/tags. Additionally, the size of each object representing each individual item grows and shrinks in accordance with the total number of visitors at each filter. The displayed items are based on the settings of the content filter. Visitors are presented in relation to the filters that they are currently viewing by small visual object, e.g. shapes, circles or dots. Visitors' movements between the objects, i.e. content items, is shown by movement of the small visual objects.

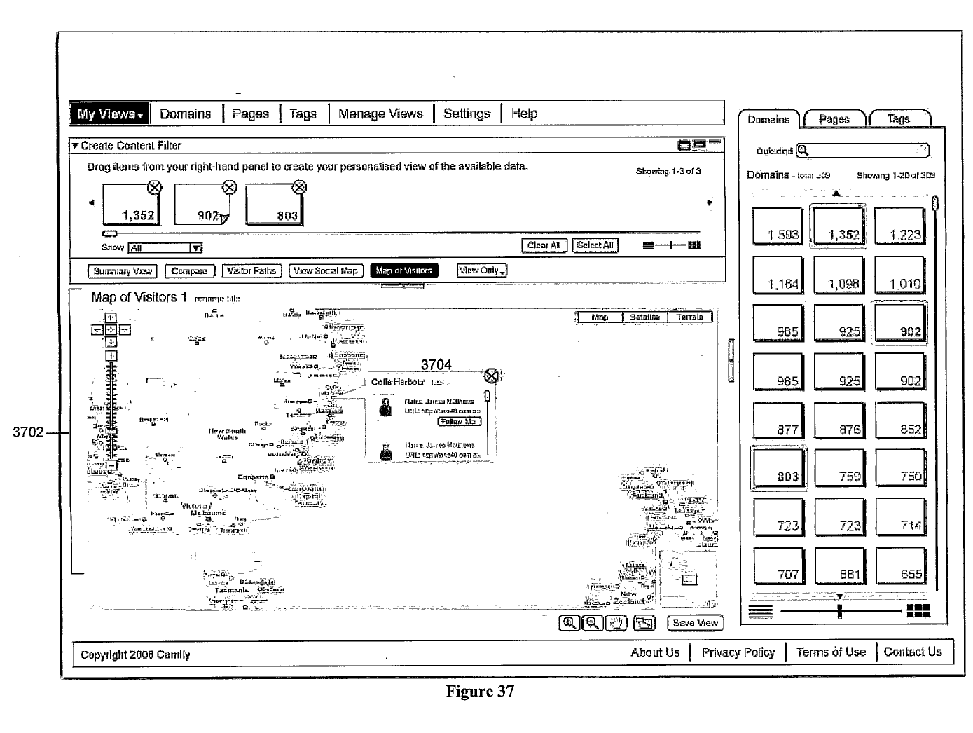

A Geographical Map view 3702, in FIG. 37, geographically plots the location of all visitors on a world map. For each plotted location the observer is able to identify the number of visitors at each location and obtain some basic details about them using a Visitor Information Flyout 3704. The visitor information flyout 3704 provides a brief set of information about the visitors at a specific location, including the URL that the visitor is currently visiting (automatically updated when the visitor moves to a different piece of content). The total number of visitors is displayed here along with the name of the location.

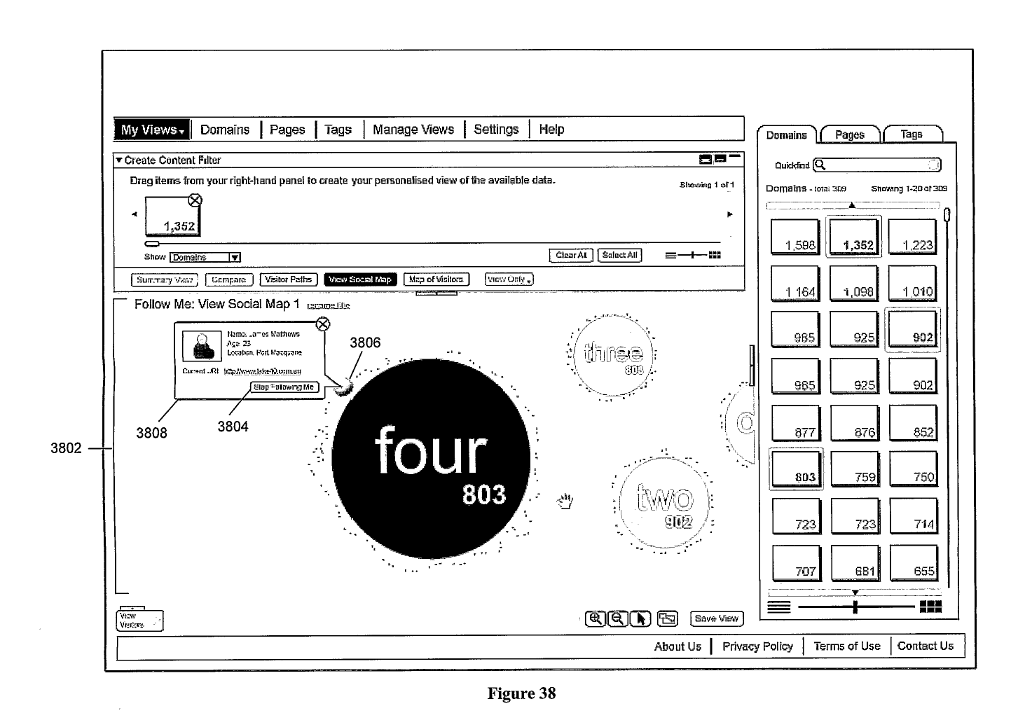

A Follow Me view 3802, in FIG. 38, provides visitor tracking feature for the observer to follow the movements of the visitor onto various domains and pages by real-time tracking. The follow me view traces the visitor's steps as they move from one content item to the next. This can be activated on any visitor at any time by clicking on the Follow Me button 3804 and deactivated by clicking on the Stop Following Me button 3804 (the same button). The view ‘view social map’ is the default view when the follow me option is activated. By activating the follow me option the observer is firstly asked to save the view and filters that they have created as the follow me option discards the current view created focusing solely on the piece of content that the visitor is currently visiting. A Current Location of Followed Visitor display focuses upon the current location of the visitor, and current location will be displayed as the largest element on the screen situated in the centre (e.g. item ‘four’ in FIG. 38). The selected visitor 3606 that is currently being followed is visually emphasised amongst the other visitors. The observer can choose to follow another visitor by retrieving the visitor's profile card and clicking on the follow me button. A Followed Visitor Profile Card 3608 is made visible while the visitor is being followed and includes a brief set of details about the visitor.

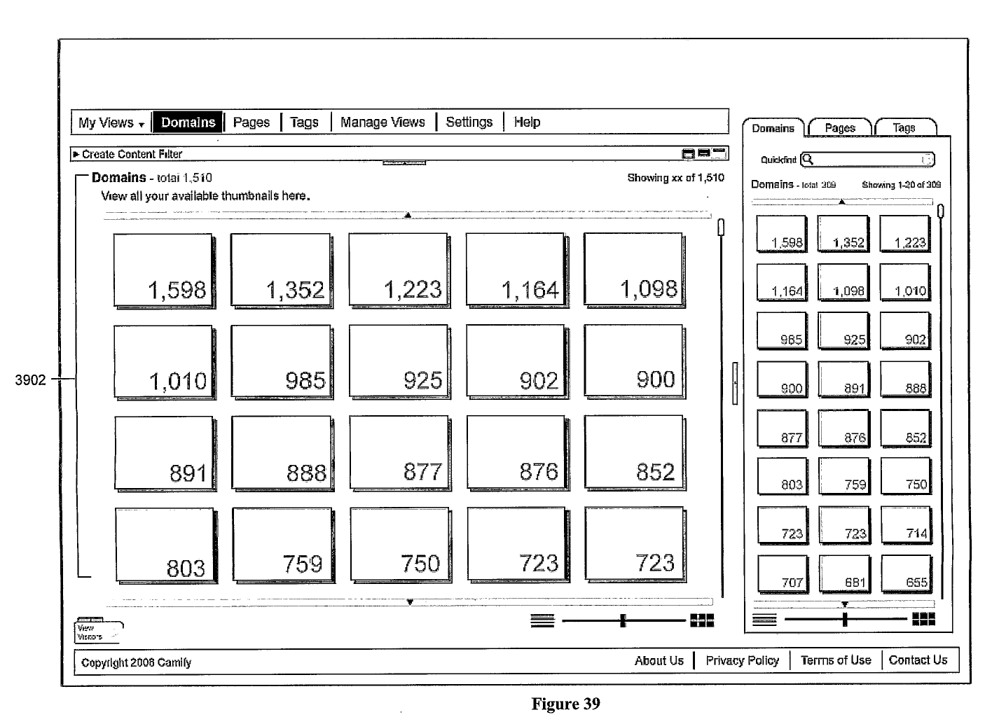

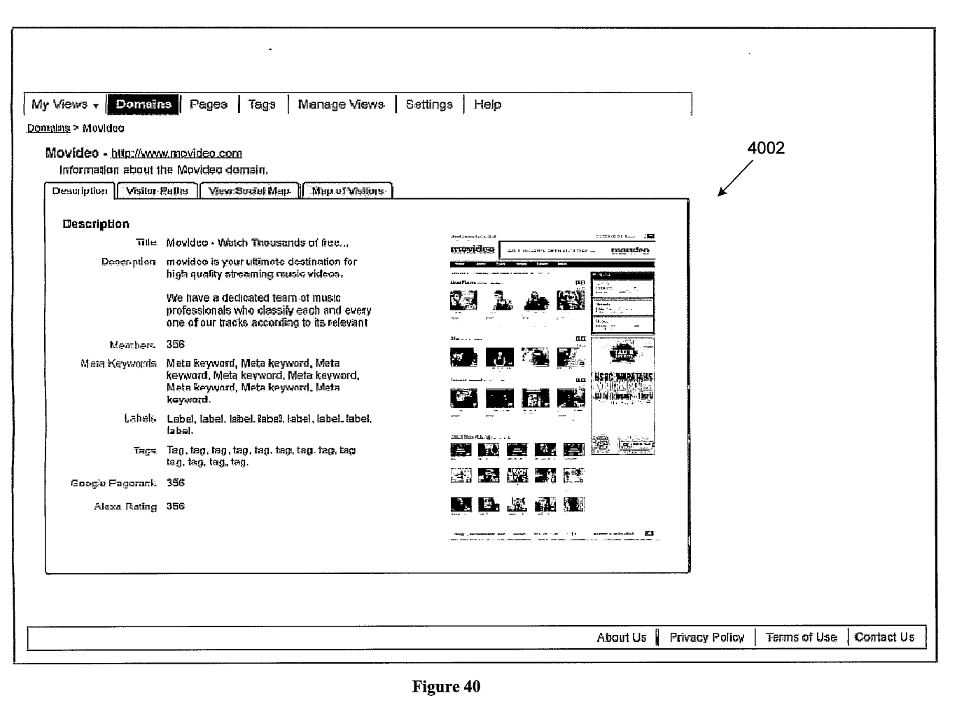

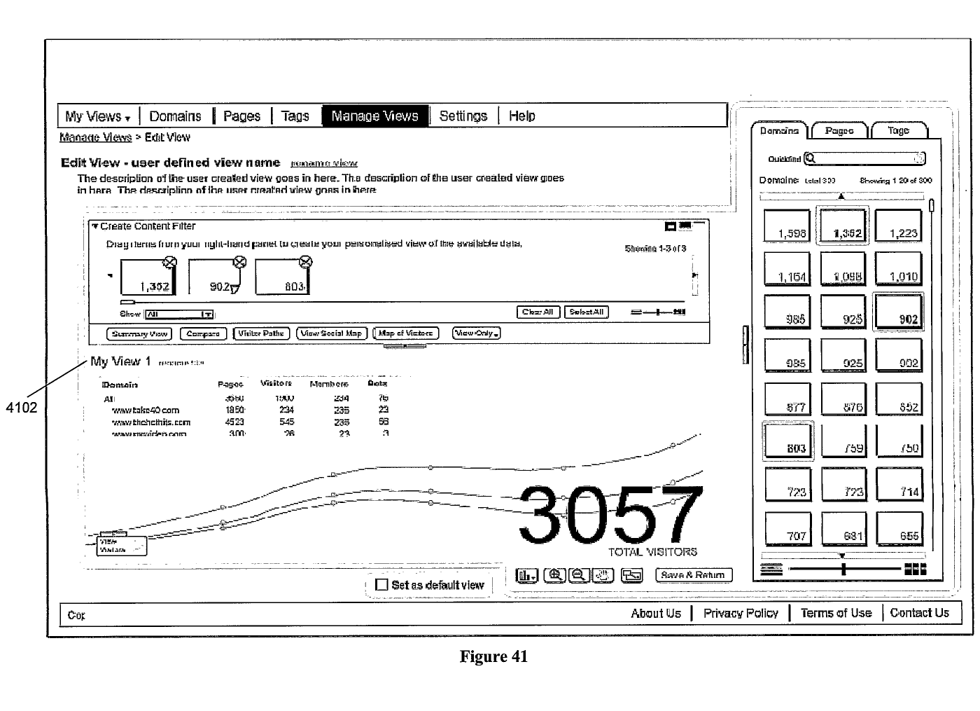

A View All Domains display 3902, in FIG. 39, provides the observer with a view of all their available domains. A View Single Domain display 4002, in FIG. 40, presents information similar to that provided within the content filter. A Manage Views display 4102, in FIG. 41, allows an observer to edit, personalise and manage their views.

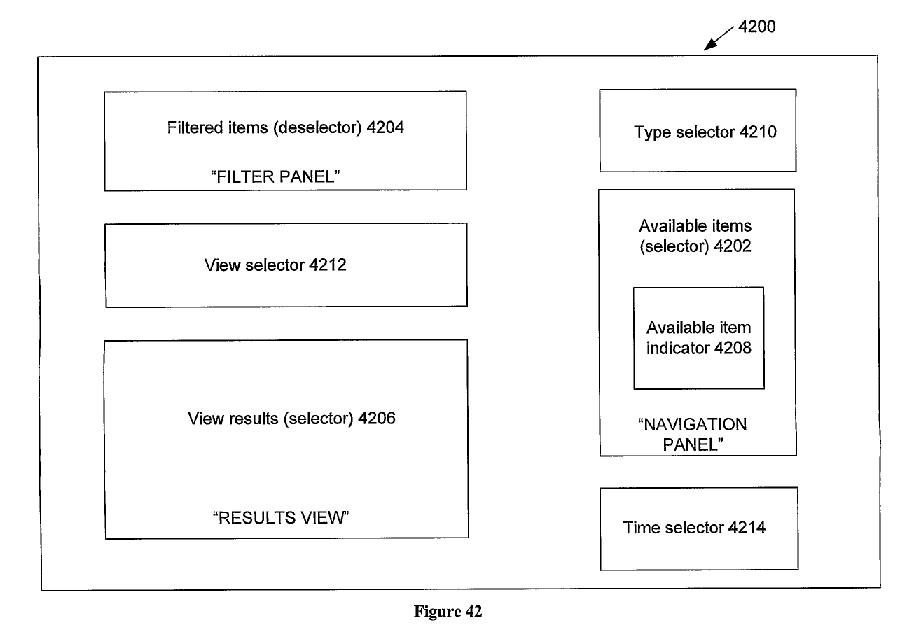

The basic view 2200 of the observer's graphical user interface (GUI), described above with reference to FIG. 22, is an example of a generalized user interface (UI) 4200 generated by the tracking system 100. The interface 4200, as shown in FIG. 42, includes the following main elements:
(a) a “navigation panel”, or available items component 4202, where available resource items, such as available Internet domains represented in the usage data, are displayed for the observer;
(b) a “filter panel” or filtered items component 4204, for displaying one or more of the resource items, selected from the available items, which are to be analysed by the tracking system 100 for the observer; and
(c) a “results view” or view results component 4206, for displaying properties of the filtered items based on one or more views and the usage data of the filtered items.

The “items” are also referred to as “objects” or “entities” and represent characteristics of the usage or activity data that has been collected. The interface 4200 presents aspects and properties of the usage data for use in search engine optimization (SEO), performance analysis, advertisement targeting, demographic filtering, and comprehension by non-technical observers, such as engineers, content editors, marketing managers and executives.

Properties of the available items are viewed by the observer who selects one or more of the available items to be filtered. The filtered items are displayed by the filtered items component 4204. The usage data of the filtered items, i.e. the items indicated in the filter panel, are analysed by the tracking system 100 to display one or more properties of the filtered items by the view results component 4206.

The interface 4200 can be used for analysis of usage data from all areas of the publishing industry and related industries. The resource items may be one or more of the following, as the processes performed by the tracking system 100 to generate and operate the display 4200 are generally subject matter agnostic. Each item represented in the display 4200, may be:
(i) an Internet domain;
(ii) a website;
(iii) a web page;
(iv) a person;
(v) a company;
(vi) a group of stores;
(vii) a store;
(viii) a franchise;
(ix) a brand name;
(x) a piece of digital content (e.g. a sequence of content items, digital image/s, text, moving/interactive pictures, audio/sound, etc); or
(xi) a software application.

The interface 4200 may be used for conveniently viewing information, trends and patterns in any usage data, such as relating to purchasing patterns by consumers in shops, or Internet usage. An example display, such as the basic view 2200 described above, is generated by a display generator (in the form of the observer client 504) for views of online data usage.

Each item has associated item properties, which depend on the type of item. An item may have one or more of the following item properties:
an item identifier (such as an item number or item ID);
(ii) a visitor or visitors (including viewers, members and users of the item);
(iii) an item type, indicative of which type of item it is (e.g. an Internet domain, a web page, a text document, an image, a label, etc.);
(iv) an item status (e.g. representing any error or warning related to the item);
(v) metadata relating to the item;
(vi) an item indicator, such as a thumbnail image representing the item; and
(vii) the relationship to other items.

The available items in the available item display 4202 are selected using a type selector 4210, such as the content selector panel 2220, shown in FIG. 22. The item type selector 4210 is a control allowing the observer to select the type of items to be displayed, e.g. Internet domains, web pages, HTML content, video content, audio content, and/or labels. Labels, also known as tags, are text data representing words descriptive of the associated item, e.g. words describing items, as shown in FIG. 30.

The available items in the available items display 4202 are represented by various styles of the available item indicator 4208. For example web content may be represented by an indicator 4208 in the form of a thumbnail or snapshot of the item, or a larger graphical image of the item, or a text based description of the item, as shown for example in FIGS. 26, 27, 28 and 29. The style of the available item indicator 4208 is controlled by a style selector such as a button control or a slider control, e.g. slider selector 2234 in the basic view 2200, as shown in FIG. 22. For certain styles, the available item indicator 4208 also indicates item properties, such as the number of viewers associated with an item of Internet content, for example as shown by numerals in the item indicators 2236 shown in FIG. 22.

Items from the available items display 4202 can be selected, after which they are displayed as filtered items in the filtered items display 4204 (represented again by item indicators). An observer selects the filtered items, as described previously, from the available items using a graphical pointer to drag and drop an available item indicator 4208 from the available items display 4202 to the filtered items display 4204.

Items may be removed from the filtered items by dragging their indicators from the filtered items display 4204, using for example a graphical computer pointer, or by clicking a “remove”/“close” button associated with each item indicator in the filtered items display 4204.

The filtered items display 4204 also has a filtered items display style selector, equivalent to the style selector for the available items display 4202. For example, in the basic view 2200, the filtered items style selector is a slider selector 2238 equivalent to the slide selector 2234 for the available items display, as shown in FIG. 22.

The view to be applied is selected using a view selector 4212 in the display 4200. For example, in the basic view 2200, the view selector 4212 is incorporated in the main navigation bar display 2204, as shown in FIG. 22, which includes controls for selecting the view, such as the myviews control 2206 and the domains/pages/tags control 2208. The view selector 4212 for the basic view 2200 also includes the control buttons 2240 entitled “summary view”, “compare”, “visitor paths”, “view social map” and “map of visitors”, as shown in FIG. 22.

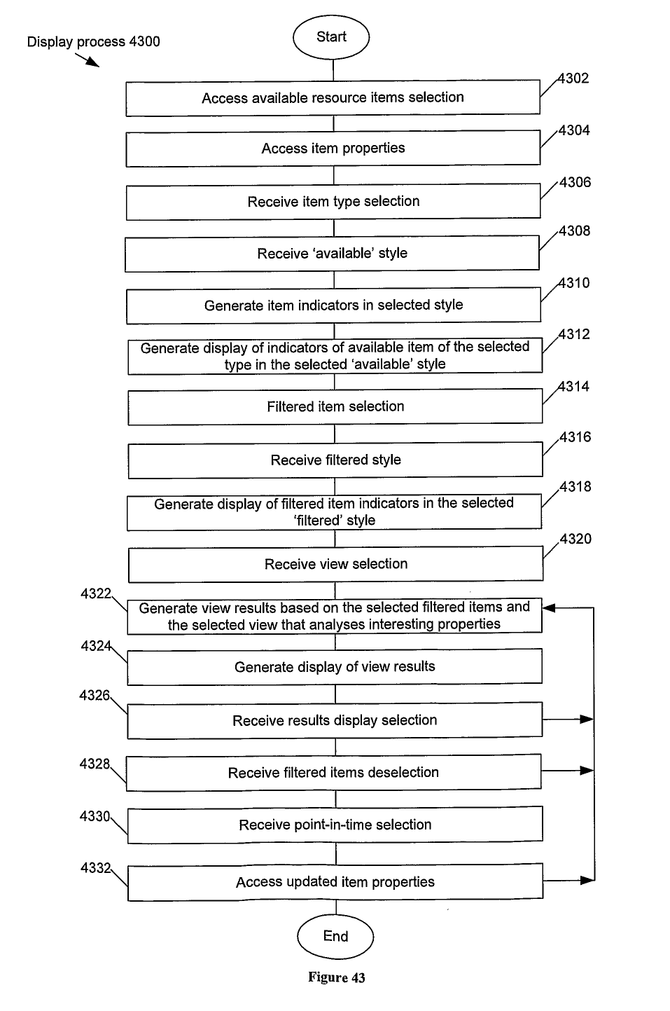

The interface 4200 is server generated and operated on under the control of a user interface display process 4300, in which item properties, represented by item properties data, are extracted from the usage data and displayed for the selected “filtered” items in a form defined by the selected view, as shown in FIG. 43. This display process 4300 commences with a display generator, such as the observer client 504, executing components of the interface 4200. The components may be part of the client 504 or the client 504 may be a web browser (such as Firefox or Internet Explorer) and the components are accessed and served by the API Server Farm 220. For serving to a web browser the interface components may include XML, JSON and JavaScript code. The JavaScript and/or AJAX code is used to provide the dynamic parts of the interface, such as the controls and selectors. The display generator accesses available resource items data for all relevant resource items for the particular observer (step 4302). The available resource items may be selected based on observer profile data (including the authentication credentials of the observer), or simply based on what resource items are represented in the usage data. The display generator accesses item properties data in the usage data (step 4304) and receives selections by the observer through the display 4200 for the item type by receiving item type selection data (step 4306), and receives the preferred style for the available items display 4202 by receiving “available” style data (step 4308). The display generator then generates the available item indicators 4208 in the selected style (step 4310), e.g. by creating thumbnails of the items. Using the available item indicator 4208 and the style selection data, the display generator generates the available items display 4202 (step 4312).

Once the available items display 4202 is generated, the display generator can receive input or control selections from the observer using the available items display 4202 to select items to be filtered (step 4314). The generator also receives “filtered” style selection data (step 4316) via the filter style selector, and uses this style with the filtered items selection data to generate the filtered items display 4204, using the item indicators (step 4318).

The generator also receives view selection data based on the observer's selection or control of the view selector 4212 (step 4320). The generator then generates the view results data based on the selected filtered items and the selected view that analyses certain view-specific properties of the items (step 4322). The exact properties that are displayed depend on the selected view, and are described below for certain example filters, including: a line chart filter, a compare view filter, a visitor map filter and a tag map filter.

The display generator generates the view results display 4206 based on the view results data (step 4324).

Once the view results display 4206 is generated, the display generator may receive selections or control data from the observer through the display 4200 (step 4326) which may cause a need to regenerate (or “refresh”) the display in step 4322. Examples of results display selection data are given below with reference to the particular views.

The display generator may also receive filtered items deselection data (step 4328) representing removal of items from the filtered items, after which the filter results data is regenerated in step 4322.

The display generator may also receive point-in-time selection data (step 4330), either from a clock indicating a certain time has passed (e.g. that an update is required on a periodic basis such as every 10 seconds), or that the observer has selected a different point in time for the view results display, using a time selector control 4214 in the display 4200. If the time for the view operation is changed, the display generator accesses updated item properties data for the new point(s) in time (step 4332) and regenerates the view results data in step 4322. In this way, the results may be periodically updated as real-time data is analysed by the display 4200.

A first view type is a line chart view, such as the graph data display 3204 where the number of visitors/viewers of a resource item is plotted as a function of time on a graph, as shown in FIG. 32. For the line chart view, the available results display selections include:
(i) a show/hide line control for selection, where a line or graph corresponding to a particular resource may be hidden or displayed;
(ii) a show/hide point details control for selection, which shows/hides detail data pertaining to a particular point in time for a particular resource, for example the number of Members, the number of non-member Visitors, the number of new visitors/viewers in relation to the previous point in time and the exact point in time associated with the data point;
(iii) a zoom/pan control for viewing different segments of the data, such as the additional view options controls 2222 (described above with reference to FIG. 22); and
(iv) a clear/refresh control, which forces regeneration of the view results data in step 4322.

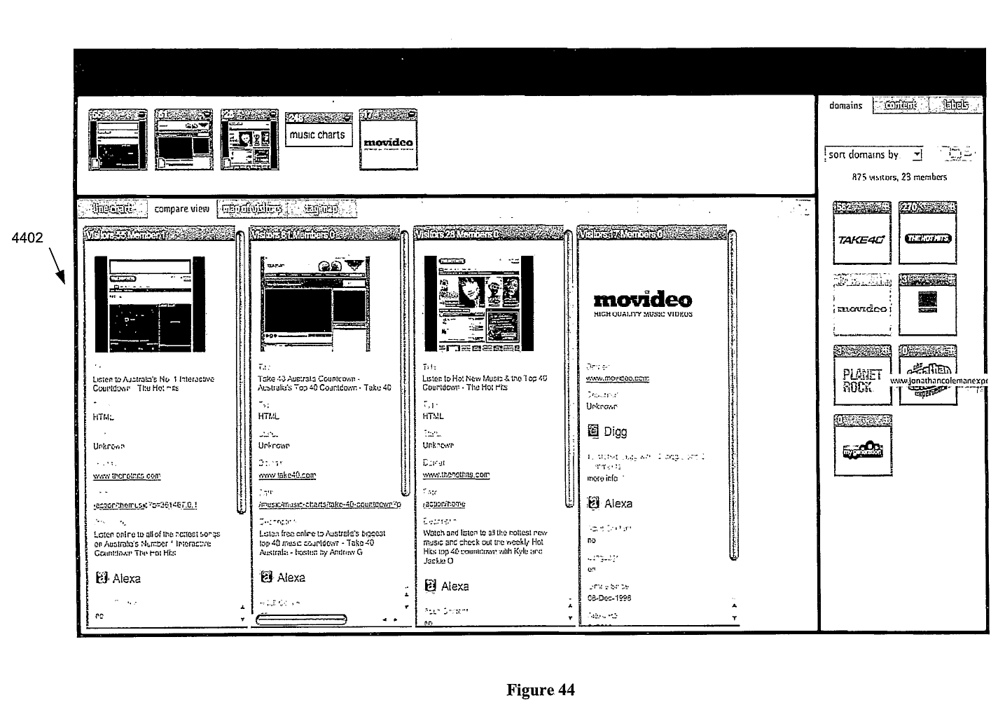

A further view type is the compare description view, where the values of the item properties for the filtered items are shown in adjacent areas of the view results display 4206, such as in the Compare View 3404, of FIG. 34, or the Compare View 4402, of FIG. 44. The compare view generates a list of the item properties and their values, including: the title; the type (e.g. HTML, or video); the status; the Internet domain; the directory path and filename (in the Internet domain); a description (drawn from metadata or labels); associated Internet data from Alexa, or Digg; and Advertizing Platforms. The compare view allows for direct comparison amongst content items to help better understand the content's composition, included mashed up content from sources such as Alexa® and Digg®.

A further view type is a visitor map view, also known as the geographical map view, which focuses on the location of visitors interacting with content. For the visitor map view, the view results display 4206 displays what visitors, indexed by their geographical location on a map, are focused on right now, what they have viewed during their session, where they are and how long their session has lasted. An example of results from a visitor map view is the geographical map view 3702 of FIG. 37. The controls of the geographical map view results display 4206 include:
(i) a zoom/pan control;
(ii) a show/hide map features control (e.g. the “map”, “satellite” or “terrain” controls of Google Maps);
(iii) a show/hide viewer details control, where an icon indicating the location of a viewer/visitor can be clicked on to show more details, e.g. using the visitor information flyer 3704, of the visitor; and
(iv) a refresh control.

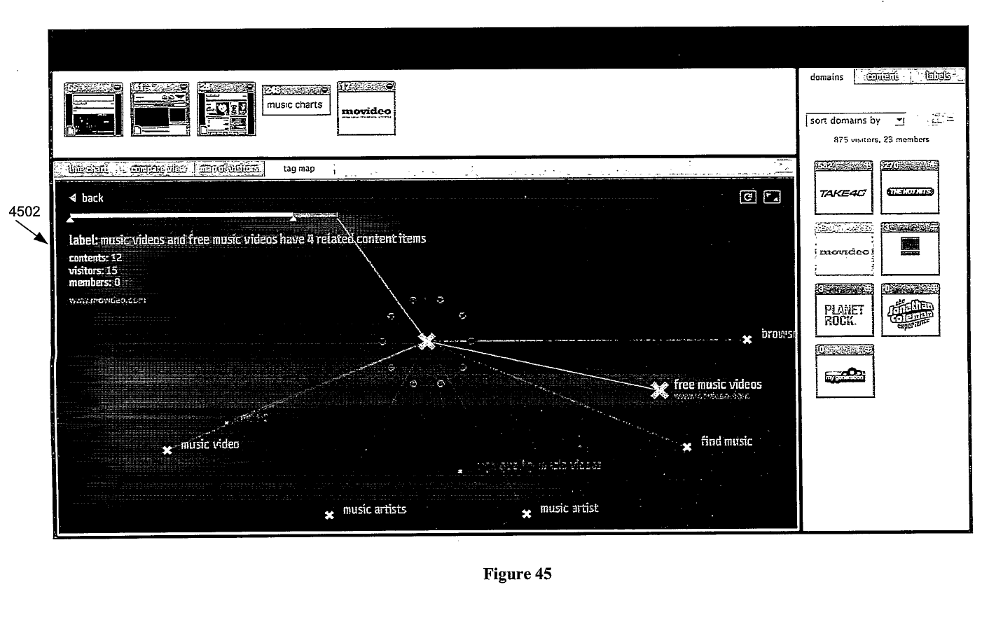

A further view type is a tag map view which generates a map or plan of the filtered items based on their tag properties, such as the tag map shown in FIG. 45. In the tag map view 4502, the tags (also known as “labels”) of the filtered items are displayed ranked in size on the view by the aggregate number of viewers viewing the content items tagged by the tag. For example, the tag “free music videos” has a larger size if more viewers are associated with filtered items that include the tag “free music videos” than the smaller tag “music”, as shown in FIG. 45. Using the tag map view, an observer may make a results display selection to select a particular tag, or a particular link between tags. The controls available in the view results display 4206 when using the tag map view include:
(i) a refresh control;
(ii) a select number of tags control, which may be a slider to select a total number of tags shown, ranked either by number or by number of viewers;
(iii) a show/hide tag details control, such as a control activated by moving a computer pointer over a particular tag which activates a fly-out showing the number of viewers for that tag, or the value and estimated value of the tag in an advertising system such as Google's “AdWords”, or the number of content items in the filtered items associated with the tag; and
(iv) a show/hide link details control, which may be activated as a fly-out by moving the computer pointer over the link, which shows the number of common items between the two tags, or the number of common viewers viewing items with the two tags, i.e. the two tags that terminate the link.

The point-in-time selection data, described above with reference to step 4330, may cause the display generator to access data in a database relating to an historical time period. For example, if the usage data relates to purchases made by purchasers in a series of supermarkets, the item properties data displayed in the view results display 4206 may relate to a present time period or a past time period, as controlled by selections made using the time selector 4214.

Developer Interface

The API server 218 may be accessed by an authenticated developer interface, through which a developer can create their own products that interact with the API server, and thus the related usage data. The API is accessed using Representational state transfer (REST) over HTTP/S, with the data formats of extensible mark up language (XML) and Javascript object notation (JSON).

The developer tools allow queries to be submitted to the API server 218 and usage data returned.

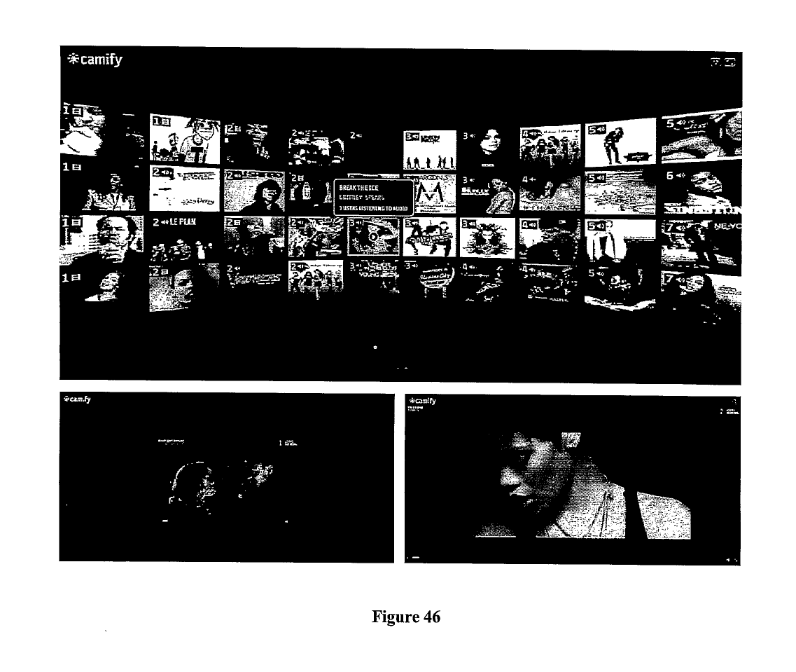

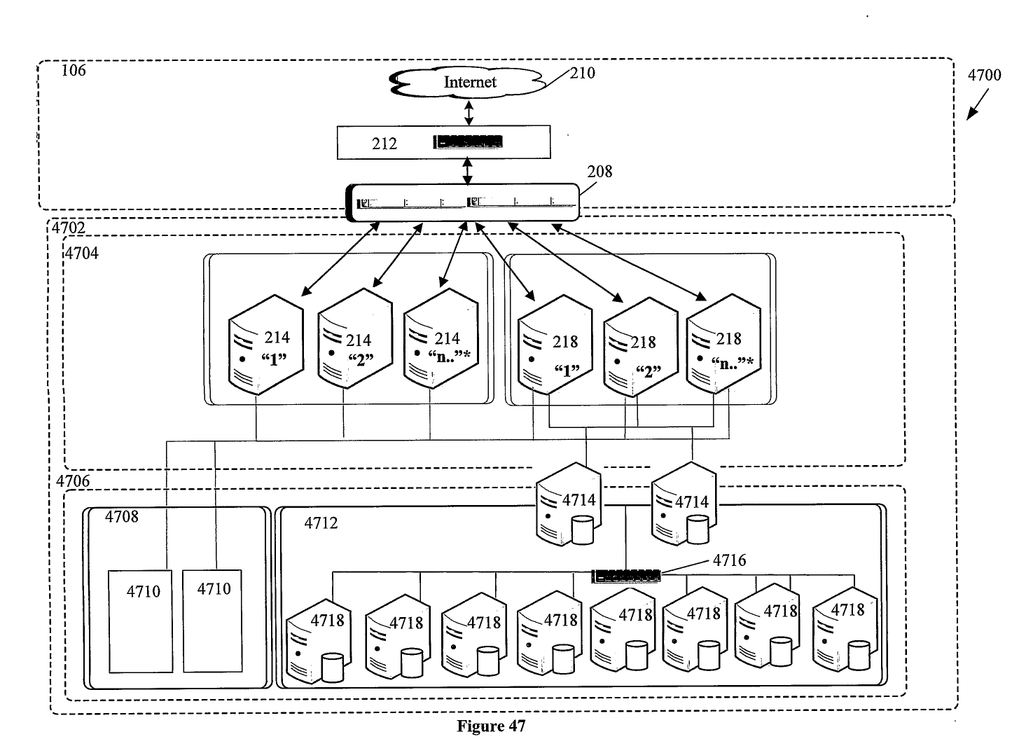

The API server 218 provides usage data to generate a media wall user interface with a media-wall client program using the developer interface. The media wall, as shown in FIG. 46, displays a virtual wall of item indicators equivalent to the item indicator 4208 described with reference to FIG. 42 above. Each indicator in the virtual wall shows a snapshot or thumbnail picture of content being displayed on the item (e.g. a webpage), together with a number relating to the number of viewers/consumers on the content. The observer can cause display of different parts of the wall by moving the computer pointer left and right (or up and down), and can zoom in and out to view groups of item indicators in greater or lesser detail.

Alternative Hardware Configuration 4700

An alternative hardware configuration 4700 of the tracking system 100, shown in FIG. 47, is substantially similar to the first hardware architecture 200 described above with reference to FIG. 2. The public network 106 includes the Internet 210 in communication with a router/switch 212 (such as a C300 router/switch from Force10 Networks Inc.), which is in communication with an external load balancer 208 configured as a firewall and for clustered failover.

The server farm 4702 in the alternative hardware configuration 4700 has similar functionality to the tracking server system 108 in the first hardware configuration 200. The server farm 4702 includes a demilitarized zone (DMZ) network 4704 in communication with the external load balancer 208, and a private network 4706 in communication with the DMZ network 4704.

The DMZ network 4704 is substantially similar to the DMZ network 202 in the first hardware configuration 200. The DMZ network 4704 includes the capture farm 216 and the API farm 220, both in communication with the load balancer 208, as in the DMZ network 202. The capture farm 216 includes the at least one capture server 214 in one or more corresponding capture server machines (indicated as “1”, “2”, . . . , “n” in FIG. 47). The API farm 216 includes the at least one API server 218 in one or more corresponding API server machines (also indicated as “1”, “2”, . . . “n” in FIG. 47).

The capture farm 216 and the API farm 220 use non-blocking input/output (I/O) at the transport layer to provide high responsiveness and resource efficiency when handling HTTP Requests. The non-blocking I/O event model is implemented using a software pattern known as the “Reactor Pattern”. The Reactor Pattern is a concurrent programming pattern for handling service requests delivered concurrently to a service handler by one or more inputs. The service handler de-multiplexes the incoming requests and dispatches them synchronously to the associated threaded request handlers.

Each capture server 214 receives the tracking data from the tracking module 602, validates the tracking data, and sends it to an alternate store 4708 (in the private network 4706) for storage and indexing. The alternate store 4708 provides the stored and processed tracking data to the API farm 220 for transmission into the public network 106, as described above in relation to the least one API server 218.

The alternate store 4708 has a similar general function to the store 228 in the first network configuration, but is configured to process the tracking data with less time delay, and to be more conveniently scaleable. The alternate store 4708 includes at least one computer appliance 4710, such as a “Vega 3” from Azul Systems, Inc. The at least one computer appliance has a plurality of central processing units (CPUs). The Vega 3 has up to 864 processor cores and 768 GB of memory per server configuration. The Vega 3 appliances can be coupled together to achieve vertical scalability and horizontal scalability over a 10 GB network to create an Azul compute pool.

The API farm 220 is in communication with a data warehouse 4712, also in the private network 4706. The data warehouse is substantially similar in function to the RDBMS 222, described above. The data warehouse 4712 communicates with the API farm 220 using a plurality of warehouse master servers 4714, connected in parallel to each API server 218, as shown in FIG. 47. The master servers 4714 are in communication with one or more storage segments 4718 via a router/switch 4716 in the data warehouse 4712.

Service Stack 4800

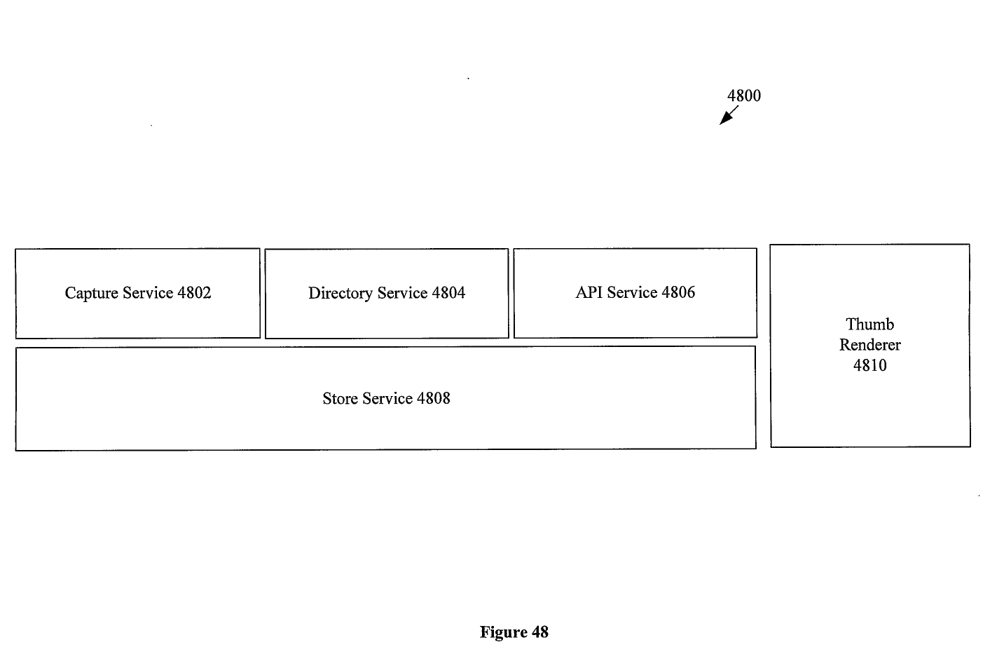

The tracking system 100 includes a service stack 4800, as shown in FIG. 48, which includes a capture service 4802 (provided by the at least one capture server 214), a directory service 4804 (provided by the RDBMS 222 or the data warehouse 4712), an Application Programming Interface (API) service 4806 (provided by the at least one API server 218), a store service 4808 (provided by the store 228 or the alternative store 4708) and a thumb renderer 4810 (provided by a render farm).

The capture service 4802 handles the serving of the tracking script and subsequent tracking data from content items. When tracking data is received, it is validated and sent to the store service 4808 for storage and indexing.

The API service 4806 allows client applications executed on a client device 104, 110 to interact and communicate with the tracking system 100 using Representational State Transfer (REST). The API service 4806 is configured to handle session management, security, data compression, data formatting, caching and input/output (I/O) handling for the store service 4808.

The store service 4808 is a distributed, shared memory resource that provides in-memory storage, indexing, searching and management of received tracking data (visitor and content data). Preferably, the store service 4808 interacts directly only with trusted services, in particular the API service 4806 and the capture service 4802.

The store service 4808 includes a Java Virtual Machine (JVM) from Azul Systems, Inc. The Azul JVM transparently provides the scalable CPU, memory and garbage collection of each compute appliance 4710 for application environments and services running on Linux, Solaris, or other hosts. Each individual Azul JVM instance can scale to the entire size of the compute appliance 4710, and multiple JVMs can dynamically share the capacity of each compute appliance 4710.

The Azul JVM, in the Azul compute appliance 4710, substantially reduces application pauses associated with garbage collection (GC). On the Azul JVM, garbage collection is concurrent with the application's execution, can continually compact memory without forcing a pause on the application, and is able to distribute free memory to threads at all times. The GC mechanism is highly parallel, scales to utilize available cores, and is able to keep up with soaring sustained allocation rates (to 10 s of GB/sec) without causing substantial application response time degradation.

The store service 4808 includes a high bandwidth interconnect, such as “DirectPath” from Azul Systems, Inc., that substantially reduces input/output (I/O) bottlenecks between application services. The DirectPath interconnect allows distributed JVMs to communicate at a rate greater than 150 Gbps over a network. A resulting decrease in transaction response time compared to existing 1 Gbs interconnects, and improved transaction throughput, yields a much higher quality of service.

The store service 4808 uses a non-blocking lock-free hash map to provide linear scalability to over 1000 CPUs/Threads at high concurrency (compared to existing solutions which begin to fail at more than 100 CPUs/Threads). The non-blocking lock-free hash map is based on Compare-And-Swap (CAS) operations. Each CAS operation is an atomic operation, that is, one CPU instruction on the x86 and Itanium chipset architectures. One CAS operation compares the contents of a memory location to a given value and, if they are the same, modifies the contents of that memory location to a new given value. As the CAS operation is an atomic operation, it is seen by the rest of the system to be a single operation with only two possible outcomes: success or failure. Use of the CAS operations allows for mass scalability by reducing the need to synchronize threads to access the memory location.

The thumb renderer 4810 is an image rendering service that is primarily responsible for rendering, storing and serving images of the tracked content items. The thumb renderer 4810 serves image information via a Representational State Transfer (REST) Application Programming Interface (API). The thumb renderer 4810 is capable of rendering content items into Portable Network Graphics (PNG) files, including content items such as Web pages, Windows Media Video (WMV) files, Advanced Stream Redirector (ASX) files, files in the H.264 and H.263 video compression formats, QuickTime (MOV) files and Flash Video (FLV) files.

The directory service 4804 is used for authentication and authorization in a substantially similar manner to the RDBMS 222, described above.

Applications and Variations

Many modifications will be apparent to those skilled in the art without departing from the scope of the present invention as herein described with reference to the accompanying drawings.

Appendix

Example Report Data

Below are some examples of XML report data that the tracking system 100 generates for sending to the observer client 504.

Session Token (Valid)

Information stored about the visitor.

<session-token>

<session-access>VALID</session-access>
<token>1234-1234-1234-1234</token> <!-- Token to be used during
the sessions -->
<key>developerKey</key>
<ip-address>/127.0.0.1</ip-address> <!-- Your IP Address -->
<referer>

http://www.yoursite.com/mycompany.html

</referer> <!-- The page you came from -->
<last-accessed>1234567890123</last-accessed> <!-- Last date you
accessed a page -->
<created>1234567890123</created> <!-- The date your session was
created -->

</session- token>

Community View

What is happening on the community at this current point in time.

<community-view>
<point>200801015172</point> <!-- The “Point in Time” that this view represents -->
<generated-date>1234567890123</generated-date>
<community-key>Mycompany</community-key>
<id>3</id> <!-- The id of your community -->
<name>The Mycompany Example Community</name>
<language>EN</language>

<domain-view>

<community-id>3</community-id>
<domain>www.mycompany.com</domain>
<domain-id>1</domain-id>
<point>200801015172</point> <!-- The “Point in Time” that this view represents -->
<generated-date>1234567890123</generated-date>
<contents>

<entry>

<key>0987654321</key> <!-- The contents key -->
<value>

<description>

The description metta tag

</description>
<content-id>

<domain>www.mycompany.com</domain>
<key>−0987654321</key>
<url>

http://www.mycompany.com/content.html

</url>

</content-id>
<labels>Label 1</labels>
<labels>Label 2</labels>
<labels>Label 3</labels>
<tag>Tag 1</tag>
<tag>Tag 2</tag>
<tag>Tag 3</tag>
<last-modified>0</last-modified>
<thumb>

http://url.com/tumb.img

</thumb> <!-- The url to a thumbnail image of your page -->
<title>

The HTML page data

</title>
<url>

http://www.mycompany.com/content.html

</url>
<visitor>

<age>26</age>
<alias>LKemp</alias>
<avatar>

http://mycompany.com/avatars/lkemp.png

</avatar>
<mycompany-id>0</mycompany-id>
<community-key>mycompany</community-key>
<content-identifier>

<community-key>mycompany</community-key>
<domain>www.mycompany.com</domain>
<key>332582168</key>
<url>

http://www.mycompany.com/content.html

</url>

</content-identifier>
<domain>www.mycompany.com</domain>
<first-content-visited>1234567890123</first-content-visited>
<first-visited>1234567890123</first-visited> <!-- The first time

the visitor visited the community -->

<gender>MALE</gender> <!-- MALE, FEMALE or UNKNOWN -->
<key>CE3E38B0-53FE-F90A-FE9C-70227E66F7BE</key> <!-- The visitors

identification key -->

<last-visited>1234567890123</last-visited>
<location>

<ip-address>10.0.10.100</ip-address>
<city>Melbourne</city>
<country>Australia</country>
<longitude>151.0</longitude>
<latitude>−33.1234</latitude>

</location>
<previous-content-identifier>

<community-key>mycompany</community-key>
<domain>www.mycompany.com</domain>
<key>339231437</key>
<url>

http://www.mycompany.com/oldContent.html

</url>

</previous-content-identifier>
<profile-url>

http://www.mycompany.com/lkemp

</profile-url>
<user-agent>

Mozilla/4.0 (compatible; MSIE 6.0; Windows NT 5.1;
SV1; .NET

CLR 1.1.4322)

</user-agent>

</visitor>

</value>

</entry>

</contents>

</domain-view>

</community-view>

Community Update

What has changed since your last view or update.

<community-update>

<generated-date>1234567890123</generated-dates>
<community-id>3</community-id>
<updated-domains>
<domain-updates>

<community-id>3</community-id>
<domain>www.mycompany.com</domain>
<domain-id>1</domain-id>
<generated-date>0</generated-date>
<point-from>200801015252</point-from>
<point-to>200801015255</point-to>

<new-content>
<content-view>

<description>

The description metta tag

</description>
<content-id>

<domain>www.mycompany.com</domain>
<key>−0987654321</key>
<url>

http://www.mycompany.com/content.html

</url>

</content-id>
<labels>Label 1</labels>
<labels>Label 2</labels>
<labels>Label 3</labels>
<tag>Tag 1</tag>
<tag>Tag 2</tag>
<tag>Tag 3</tag>
<last-modified>0</last-modified>
<thumb>

http://url.com/tumb.img

</thumb> <!-- The url to a thumbnail image of your page -->
<title>

The HTML page data

</title>
<url>

http://www.mycompany.com/content.html

</url>
<visitor>

<age>26</age>
<alias>LKemp</alias>
<avatar>

http://mycompany.com/avatars/lkemp.png

</avatar>
<mycompany-id>0</mycompany-id>
<community-key>mycompany</community-key>
<content-identifier>

<community-key>mycompany</community-key>
<domain>www.mycompany.com</domain>
<key>332582168</key>
<url>

http://www.mycompany.com/content.html

</url>

</content-identifier>
<domain>www.mycompany.com</domain>
<first-content-visited>1234567890123</first-content-visited>
<first-visited>1234567890123</first-visited> <!-- The first time the

visitor visited the community -->

<gender>MALE</gender> <!-- MALE, FEMALE or UNKNOWN -->
<key>CE3E38B0-53FE-F90A-FE9C-70227E66F7BE</key> <!-- The visitors

identification key -->

<last-visited>1234567890123</last-visited>
<location>

<ip-address>10.0.10.100</ip-address>
<city>Melbourne</city>
<country>Australia</country>
<longitude>151.0</longitude>
<latitude>−33.1234</latitude>

</location>
<previous-content-identifier>

<community-key>mycompany</community-key>
<domain>www.mycompany.com</domain>
<key>339231437</key>
<url>

http://www.mycompany.com/oldContent.html

</url>

</previous-content-identifier>
<profile-url>

http://www.mycompany.com/lkemp

</profile-url>
<user-agent>

Mozilla/4.0 (compatible; MSIE 6.0; Windows NT 5.1; SV1; .NET CLR

1.1.4322)

</user-agent>

</visitor>

</content-view>

</new-content>
<updated-content>

<content-update>

<url>http://www.mycompany.com/action/home</url>
<content-id>

<domain>www.mycompany.com</domain>
<key>−1894022047</key>
<url>http://www.mycompany.com/action/home</url>

</content-id>
<new-visitor>

<age>0</age>
<mycompany-id>0</mycompany-id>
<community-key>mycompany</community-key>
<content-identifier>

<community-key>mycompany</community-key>
<domain>www.mycompany.com</domain>
<key>−1894022047</key>
<url>http://www.mycompany.com/action/home</url>

</content-identifier>
<domain>www.mycompany.com</domain>
<first-content-visited>1234567890123</first-content-visited>
<first-visited>1234567890123</first-visited>
<key>5DA6167A-CDB4-D498-DA9E-4989996E9947</key>
<last-visited>1234567890123</last-visited>
<location>

<ip-address>10.0.1.2</ip-address>
<country>Australia</country>
<longitude>133.0</longitude>
<latitude>−27.0</latitude>

</location>
<user-agent>

Mozilla/5.0 (Windows; U; Windows NT 5.1; en-US; rv:1.8.0.12)

Gecko/20070508 Firefox/1.5.0.12

</user-agent>

</new-visitor>
<removed-visitor>AF1A3E90-DBFD-EFE0-C4E9-A034F4269946</removed-visitor>
<removed-visitor>1DD03647-ACC2-9EC2-27E1-66C7299C3E0F</removed-visitor>

</content-update>

</updated-content>

<removed- content>

<contentid>AF1A3E90-DBFD-EFE0-C4E9-A034F4269946</contentid>

</removed-content>

</domain-update>
</updated-domains>
<point-from>200801015252</point-from>
<point-to>200801015255</point-to>

</community-update>

Content

Information about a specific content item within a community.

<content>
<community-key>mcm</community-key>

<description>

The HTML meta description of the page

</description>
<content-id>

<community-key>mycompany</community-key>
<domain>www.mycompany.com</domain>
<key>1535234594</key>
<url>

http://www.mycompany.com/action/xxx

</url>

</content-id>
<labels>Label 1</labels>
<labels>Label 2</labels>
<labels>Label 3</labels>
<tag>Tag 1</tag>
<tag>Tag 2</tag>
<tag>Tag 3</tag>
<last-modified>0</last-modified>
<published>01/10/2008 13:16:49</published>
<thumb>

http://mycompany.com/thumb

</thumb>
<title>

HTML Page title

</title>
<url>

http://www.mycompany.com/action/xxx

</url>
<visitor-ids>

<visitor-id>

<domain>www.mycompany.com</domain>
<community-key>mycompany</community-key>
<key>6A078DC5-283E-2801-EEAE-44B0A6B530DD</key>

</visitor-id>

</visitor-ids>

</content>

Visitor

Information about a specific visitor using a Mycompany community.

<visitor>

<age>26</age>
<alias>Lkemp</alias>
<avatar>

http://mycompany.com/avatars/lkemp.png

</avatar>
<mycompany-id>0</mycompany-id>
<community-key>mycompany</community-key>
<content-identifier>

<community-key>mycompany</community-key>
<domain>www.mycompany.com</domain>
<key>332582168</key>
<url>

http://www.mycompany.com/content.html

</url>

</content-identifier>
<domain>www.mycompany.com</domain>
<first-content-visited>1234567890123</first-content-visited>
<first-visited>1234567890123</first-visited> <!-- The first

time the visitor visited the community -->

<gender>MALE</gender> <!-- MALE, FEMALE or
UNKNOWN -->
<key>CE3E38B0-53FE-F90A-FE9C-70227E66F7BE</key>

<!-- The visitors identification key -->

<last-visited>1234567890123</last-visited>
<location>

<ip-address>10.0.10.100</ip-address>
<city>Melbourne</city>
<country>Australia</country>
<longitude>151.0</longitude>
<latitude>−33.1234</latitude>

</location>
<previous-content-identifier>

<community-key>mycompany</community-key>
<domain>www.mycompany.com</domain>
<key>339231437</key>
<url>

http://www.mycompany.com/oldContent.html

</url>

</previous-content-identifier>
<profile-url>

http://www.mycompany.com/lkemp

</profile-url>
<user-agent>

Mozilla/4.0 (compatible; MSIE 6.0; Windows NT 5.1; SV1;
.NET CLR 1.1.4322)

</user-agent>

</visitor>

Total

An overview of the amount of visitors and content items in a community.

<community-total>

<members>0</members>
<domains>3</domains>
<visitors>269</visitors>
<content>144</content>
<domain-total>

<domain-id>1</domain-id>
<domain>www.mycompany.com</domain>
<members>0</members>
<visitors>268</visitors>
<content>143</content>

</domain-total>
<domain-total>

<domain-id>2</domain-id>
<domain>www.blah.com</domain>
<members>0</members>
<visitors>0</visitors>
<content>0</content>

</domain-total>
<community-key>mycompany</community-key>

</community-totals

1. A method of generating a user interface on a client computer device for displaying resource item usage, including:
generating a display, in a first part of the interface, of available resource items associated with usage data, said items being selectable using the interface;
receiving a selection of the resource items from the available resource items in said first part;
generating a display of filtered resource items in a second part of said interface based on the selection;
receiving a selection of a view associated with at least one property of the filtered items; and
generating a display, in a third part of said interface, of said view using the filtered resource items' usage data associated with said at least one property.

2. A method as claimed in claim 1, wherein said resource items respectively represent usage data associated with one of a domain, a content item, and a label characterising the respective usage data.

3. A method as claimed in claim 2, wherein the domain is an Internet domain, and the content item is a webpage, a software application or a media resource.

4. A method as claimed in claim 1, 2 or 3, wherein the property is a number of entities associated with use of the resource item.

5. A method as claimed in claim 1, 2, 3 or 4, wherein the view represents numbers of entities associated with use of the filtered resource items and demographic data associated with the entities.

6. A method as claimed in claim 1, 2, 3 or 4, wherein the view represents a line chart of the number of entities associated with use of the resource items.

7. A method as claimed in claim 1, 2, 3 or 4, wherein the view is a comparison view displaying data of the selected filtered resource items for comparison.

8. A method as claimed in claim 1, 2, 3 or 4, wherein the view presents a map of the geographic location of entities associated with use of the resource items.

9. A method as claimed in claim 8, wherein the geographic map is selectable to present data associated with individual users of the resource items.

10. A method as claimed in claim 2, 3 or 4, wherein the view is a tag map view providing a map of the filtered items based on a label, and sized according to the number of entities associated with use of items with the label.

11. A method as claimed in any one of the preceding claims, wherein said receiving said selection includes dragging and dropping selected available resource items into said second part.

12. A method as claimed in any one of the preceding claims, wherein said usage data is processed in real-time, and said interface is dynamically updated in real-time based on said usage data.

13. A computer program product stored on computer readable media and including code for performing a method as claimed in any one of the preceding claims.

14. A usage data analysis system, including an application server for accessing and processing usage data representing use of items, and serving an interface, including:
selectable identifiers, associated with said items to select items for display as filtered items according to the selected identifier; and
selectable views for presenting data associated with the filtered items, including at least one of:
(i) demographic data associated with users of the items,
(ii) numbers of users of said items,
(iii) comparison data between said filtered items,
(iv) geographic data associated with the location of said users, and
(v) tag map data based on said filtered items having tags associated with the items, and presenting the relationship between the tagged items.

15. A system as claimed in claim 14, wherein the identifiers include categories, characteristics and labels.

16. A system as claimed in claim 14, wherein the identifiers represent domains, content items and labels associated with content items.

17. A system as claimed in claim 14, wherein said views are updated dynamically whilst said items are used.

18. A system for tracking usage, including:
a capture server for receiving usage data, indicating that a resource is being used by a visitor using a visitor client, from a tracking module having been served to the visitor client; and
a report server for serving report data in real-time, based on usage data on the visitor client devices using a plurality of resources.

19. The system of claim 14, wherein said resources are media items, including video or audio content.

20. The system of claim 14, wherein said report server aggregates visitors into groups corresponding to respective media resources.

21. The system of claim 14, wherein the report server generates ranking data indicating popularity of a plurality of media resources in the form of streaming videos based on the tracked number of visitors using each streaming video.

22. The system of claim 14, wherein the report server generates location data, indicating a geographical location of the visitor, from the usage data.

23. A usage data analysis system, including an application server for serving code for generating a comparison view in real-time presenting a comparison between historical usage data and real-time usage data, said usage data representing use of a resource by a user.

24. The system of claim 23, wherein said resource is one of an Internet domain, a web site, and a resource stored on server and accessible over the Internet.
